(19) United States
(12) Patent Application Publication
(10) Pub. No.: US 2026/0040338 A1
(43) Pub. Date: Feb. 5, 2026

(54) CONDITIONAL AVAILABILITY OF DATA FOR TRANSMISSION

(71) Applicant: InterDigital Patent Holdings, Inc., Wilmington, DE (US)

(72) Inventors: Tejaswinee Lutchoomun, Montreal (CA); Ghyslain Pelletier, Montreal (CA)

(73) Assignee: InterDigital Patent Holdings, Inc., Wilmington, DE (US)

(21) Appl. No.: 18/794,093

(22) Filed: Aug. 5, 2024

(51) Int. Cl. H04W 72/50

(52) U.S. Cl. CPC H04W 72/50

(57) ABSTRACT

A device may determine conditional availability of data for transmission. A device (e.g., in medium access control (MAC), radio link control (RLC), and/or packet data convergence protocol (PDCP) may determine a second amount of data is available for conditional transmission (e.g., for a scheduling request (SR), buffer status report (BSR), and/or multiplexing in a transport block (TB)) as a function of, e.g., the transmission status of a first amount of data multiplexed in a TB, available for transmission, discarded, and/or transmitted. In examples, a device may receive an indication of first data, receive an indication of second data, determine that a dependency exists between the first and second data, determine the second data is unavailable for transmission, determine condition(s), determine an amount of the second data is available for transmission based on satisfaction of the condition(s), and perform transmission processing or transmission of the amount of the second data.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein related to conditional availability of data for transmission, e.g., for data streams related to immersive services and/or extended reality (XR). A wireless transmit/receive unit (WTRU) may determine that a second amount of data is available for transmission (e.g., for the purpose of a scheduling request (SR), buffer status report (BSR), and/or multiplexing in a transport block (TB)) as a function of, for example, the transmission status of a first amount of data that has previously been multiplexed in a transport block, previously determined to be available for transmission, previously discarded, and/or previously successfully transmitted. The determination logic may be performed, for example, in medium access control (MAC), radio link control (RLC), and/or packet data convergence protocol (PDCP). The WTRU may use the determination to implement conditional transmission of the second amount of data.

An example device may include a processor and may be configured to perform one or more actions. For example, a device (e.g., a wireless transmit/receive unit (WTRU)) may (e.g., be configured to) receive an indication of first data. The device may receive an indication of second data. The device may determine that a dependency exists between the first data and the second data. The device may determine, at a first time, that the second data is unavailable for transmission. The device may determine one or more conditions. Satisfaction of the one or more conditions may indicate that at least an amount of the second data is available for transmission. The device may determine, at a second time, that the amount of the second data is available for transmission based on satisfaction of the one or more conditions. The device may perform one or more of: processing (e.g., transmission processing) of the amount of the second data or transmission of the amount of the second data.

The determination that the dependency exists between the first data and the second data may comprise a determination that: the first data and the second data are mapped to a flow, a bearer, or a logical channel; or, information provided by a higher layer indicates the dependency between the first data and the second data. The indication may be associated with one or more of: grouping information, marking information, or time stamp information.

The determination that the second data is unavailable for transmission may be based on: a processing status of the first data; a configuration of the WTRU; or, at least one of: an attribute of the first data or an attribute of the second data.

The attribute of the first data may comprise a packet delay budget (PDB), protocol data unit (PDU) set delay budget (PSDB), PDU set delay deadline (PSDD), or PDU Set Importance (PSI). The attribute of the second data may comprise an indication that the second data has not been received (e.g., the second data may not have been received, may have been partially received (e.g., not totally received), or the received data may be corrupted).

The transmission of the amount of the second data may be performed. The amount of the second data may be a subset of the second data. The transmission of the subset of the second data may not include part of the second data. The amount of the second data may be determined, for example, based on an amount of the first data being processed for transmission. In examples, being processed for transmission may comprise being multiplexed into a transport block.

The one or more conditions may comprise one or more time-based conditions. The one or more of time-based conditions may comprise at least one of: a jitter condition associated with an expected time to receive the second data; or, a packet delay budget (PDB) condition, a protocol data unit (PDU) set delay budget (PSDB) condition, or a PDU set delay deadline (PSDD) condition.

The one or more conditions may comprise one or more event-based conditions. The one or more event-based conditions may comprise at least one of: whether the second data has been received; whether the first data is available for transmission; whether dependent data has been received; a hybrid automatic repeat request (HARQ) condition; or, a forward error correction (FEC) condition.

The one or more conditions may comprise a time-based condition and an event-based condition.

The processing of the amount of the second data may be performed. The processing of the amount of the second data may comprise multiplexing the amount of the second data into a packet data unit (PDU). The transmission of the amount of the second data may be performed.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of determining conditional availability of data for transmission.

FIG. 3 illustrates an example of determining conditional availability of data for transmission.

### DETAILED DESCRIPTION

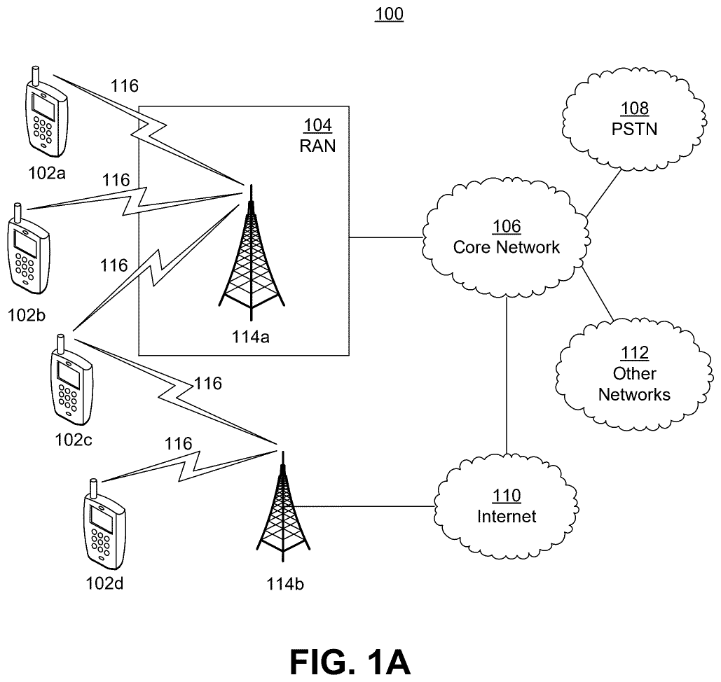

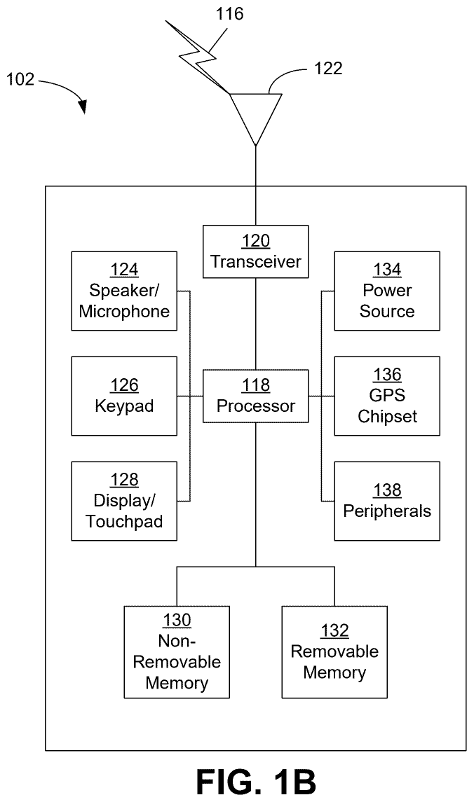

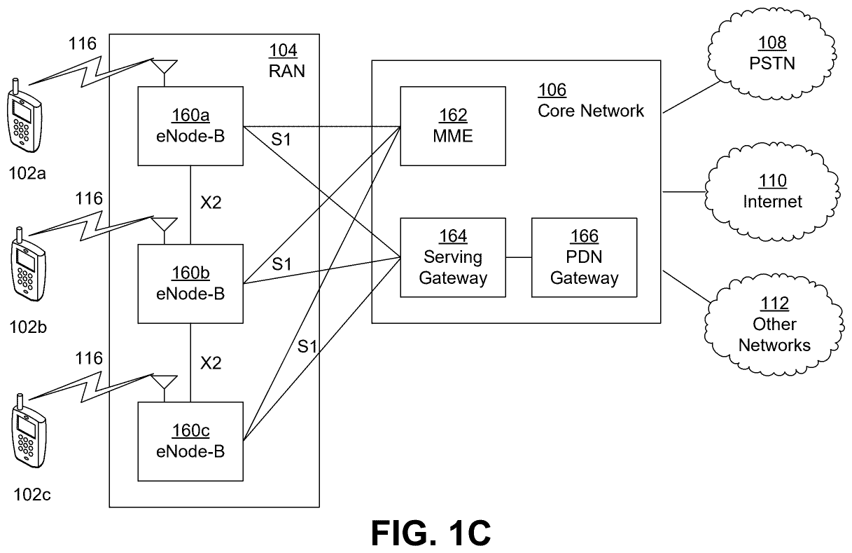

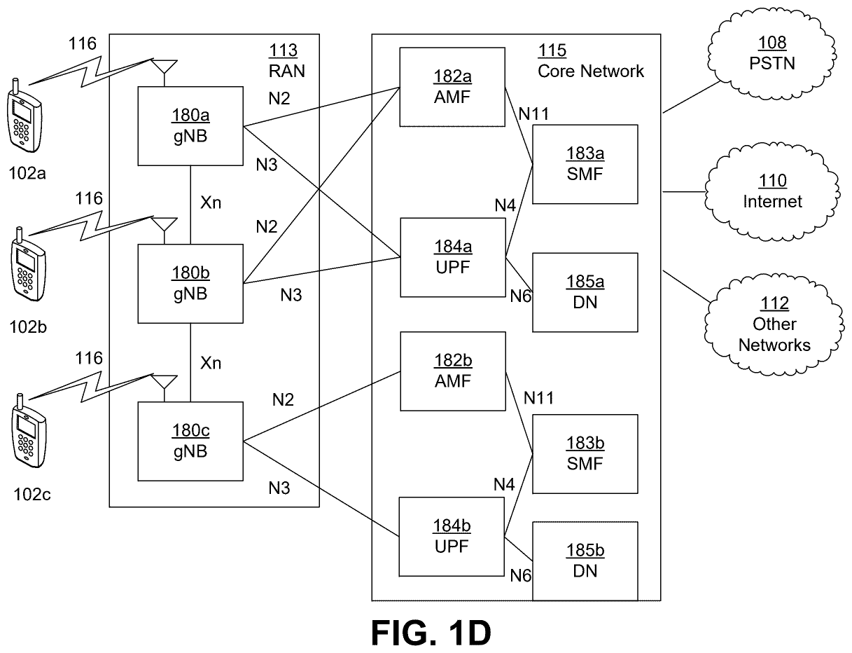

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein related to conditional availability of data for transmission, e.g., for extended reality (XR). A wireless transmit/receive unit (WTRU) may determine that a second amount of data is available for transmission (e.g., for the purpose of a scheduling request (SR), buffer status report (BSR) and/or multiplexing in a transport block (TB) as a function of, for example, the transmission status of a first amount of data that has previously been multiplexed in a transport block, previously determined to be available for transmission, previously discarded, and/or previously successfully transmitted. The determination logic may be performed, for example, in medium access control (MAC), radio link control (RLC), and/or packet data convergence protocol (PDCP). The WTRU may use the determination to implement conditional transmission of the second amount of data.

Wireless system transport data streams may be associated with different services and/or applications. Data may be transported as different flows. A (e.g., each) service and/or application may transmit data associated to a plurality of flows. A (e.g., each) flow may be associated to a (e.g., specific) Quality of Service (QoS). Data units for different applications may be assigned to different flows or grouped together, e.g., according to different strategies. For example, video may be coded as base layer and enhancement layer. Different data units may represent different type of information for the decoding process (e.g., I-frame, B-frame, P-frames) and/or may represent different areas of the field of view (FoV) for a given user, for example. Applications may (e.g., further) use forward error correction (application layer forward error correction (AL-FEC)), for example, such that additional repair data may be available at the receiver, e.g., if needed, such as if/when a data unit may be lost or delayed beyond an acceptable amount of time at some point in the transmission path between transmitter and sender. Different AL-FEC algorithms may implement different strategies, for example, as described herein.

Data units from a given service and/or given application may be differentiated, for example, in terms of their impact to the quality of service (QoS) and/or quality of experience (QoE) of the end user. An impact may vary over time and/or may be dependent on the reception status of other, e.g., related, data units.

Data streams may be related to immersive services and/or extended Reality (XR). The term extended Reality (XR) may be an umbrella term for different types of immersive experiences, including, for example, Virtual Reality (VR), Augmented Reality (AR), Mixed Reality (MR), and the realities interpolated among the various types of immersive experiences. Virtual Reality (VR) may be a rendered version of a delivered visual and/or audio scene. A rendering may be designed to mimic the visual (e.g., stereoscopic 3D) and/or audio sensory stimuli of the real world (e.g., as naturally as possible) to an observer or user as the observer or user moves within the limits defined by the application. Augmented Reality (AR) may be when a user is provided with additional information, artificially generated objects/items, and/or content overlaid upon their current environment. Mixed Reality (MR) may be an advanced form of AR where, for example, one or more virtual elements may be inserted into the physical scene, e.g., with the intent to provide the illusion that the elements are part of the real scene. XR may include (e.g., all) real-and-virtual combined environments and/or human-machine interactions generated by computer technology and wearables. The notion of immersion in the context of XR applications/services may refer to the sense of being surrounded by a virtual environment and/or providing the feeling of being physically and/or spatially located in the virtual environment. The levels of virtuality may range from partial sensory inputs to fully immersive multi-sensory inputs, which may lead to a virtual reality practically indiscernible from actual reality.

Traffic (e.g., in XR services and applications) may include data/protocol data units (PDUs), which may be associated with an application data unit (ADU), PDU set, or data burst. In an example, the PDUs belonging to a PDU set may be associated with different segments or components of a video frame or a video slice. A data burst may include one or more PDU sets that may be transmitted/received over a time window. For example, a number of PDUs in an PDU set or data burst transmitted in uplink (UL) and/or received in downlink (DL) may be dependent on the type of the media frame (e.g., 3D video frame, audio frame).

A WTRU (e.g., executing an XR application) may transmit XR traffic, which may include one or more PDUs/PDU sets in UL (e.g., pose, gesture, video data), and/or may receive XR traffic in DL (e.g., video, audio, haptics). Traffic may be transmitted and/or received periodically or aperiodically in one or more data flows (e.g., QoS flows). During UL transmissions, XR traffic may arrive from the application layer at a WTRU and/or from different devices/terminals/WTRUs (e.g., via sidelink, WiFi, or wired connection) at different time instances. XR traffic may be characterized by different attributes, such as variable payload sizes per PDU set, variable number of PDUs per PDU set, variable per-PDU/PDU set level importance, and/or different levels of inter-dependencies between PDUs/PDUs sets. XR traffic (e.g., PDU/PDU sets) received by a WTRU may (e.g., also) experience different delays, jitter, data rate, and/or loss rate. A QoS and/or high user experience (e.g., QoE) may be provided, for example, by performing data transmission/reception and/or other associated functions (e.g., prioritization, multiplexing, scheduling) on timely basis with XR awareness (e.g., awareness of PDU set attributes).

Application layer Forward Error Correction (AL-FEC) may be implemented. There may be different types of data output from an AL-FEC process, for example, depending on the encoding scheme at the codec.

For example, an FEC encoder may encode one or more data units and/or may output N coded data units, e.g., where any K coded data units out of N may be sufficient to successfully decode the initial data unit(s). N, and/or K may represent an equal or larger number than the number of data units used as input to the encoding process. N-K data units may (e.g., thus) be available to compensate, for example, if/when fewer than K coded data units are received at the receiver.

For example, K coded data units may be source PDUs. For example, N-K coded data units may be repair PDUs.

An application may generate data units that may be used as enhancement and/or mitigation of error propagation at the receiver.

There may be multiple application data types. Multiple AL-FEC data types may be described herein, which may be referred to as a data packet or PDU of the AL-FEC process. A packet/PDU type may refer, for example, to any one or more of the following: a source PDU, a repair PDU, and/or an enhancement PDU.

A source PDU may include a data unit. An application may successfully recover the initial application data, for example, if/when all source PDUs are received. For example, source PDUs may be used for successful decoding of application level data.

A repair PDU may be generated from a source PDU. A repair PDU may be used to reconstruct a source PDU. One or more repair PDU(s) may be considered redundant information, for example, if the corresponding source PDU(s) are received by the receiving application and/or if the repairs PDU(s) included application data that has been successfully decoded from the transmission of other PDUs (e.g., source PDUs).

An enhancement PDU may provide (e.g., additional) application-level information. A higher QoS and/or QoE may be achieved, for example, if/when enhancement PDU data is received by the application. An enhancement PDU may provide (e.g., to an application) error propagation mitigation, error concealment, and/or error recovery capabilities. An enhancement PDU may be generated (e.g., directly), for example, from an application encoding (e.g., video coded enhancement layer), from the one or more application level data units used as input to the AL-FEC encoding, or from source and/or repair PDUs. For example, an enhancement PDU may not be considered as critical (e.g., or mandatory) because the receiver may (e.g., be able to) determine/predict a missing enhancement PDU from another PDU (e.g., a source PDU). For example, a video frame delivered without any enhancement PDUs may still be considered as successfully delivered.

There may be dependencies between data units. For example, there may be dependencies between source and repair data units.

A repair data unit may be generated from a source data unit. The source: repair dependencies between the repair data unit and the source data unit may be characterized, for example, in any one or more of the following ways: 1:1; 1:1 but not every source packet may generate a repair packet; 1:M; and/or M:1.

A source: repair dependency between the repair data unit and the source data unit may be characterized as 1:1. For example (e.g., in a 1:1 dependency), every source packet may generate a repair packet. For example (e.g., in a 1:1 dependency), there may exist a (e.g., direct) dependency between the source packet and the repair packet generated from the source packet.

A source: repair dependency between the repair data unit and the source data unit may be characterized as 1:1, but not every source packet may generate a repair packet. For example, a source packet may generate a repair packet. For example, a repair packet may be used to reconstruct the source packet it was generated from. For example, a repair packet may be used to reconstruct another source packet that it was not generated from, e.g., a source packet that is adjacent to the source packet it was generated from.

A source: repair dependency between the repair data unit and the source data unit may be characterized as 1:M. For example (e.g., in a 1:M dependency), a source packet may generate multiple repair packets. For example, one or more repair packets may be used to reconstruct the source packet. For example, multiple repair packets may be used to reconstruct the source packet.

A source: repair dependency between the repair data unit and the source data unit may be characterized as M:1. For example, several source packets may be used to generate a repair packet. For example, the repair packet may be used to reconstruct any one or more of the source packets used to generate the repair packet.

Dependencies may be visible at the application in the WTRU. Dependency information may be available to the data transmission process in a transmitting device (e.g., a WTRU). For example, the WTRU (e.g., lower layers) may receive an indication of dependencies from the application layer.

There may be dependencies between source and enhancement data units. An enhancement data unit may be generated from a source and/or a repair data unit. Enhancement dependencies between the source and/or repair data unit and the enhancement data unit may be characterized, for example, in any one or more of the following ways: 1:1; 1:1 but not every source and/or repair packet may generate an enhancement packet; 1:M; and/or M:1.

Enhancement dependencies between the source and/or repair data unit and the enhancement data unit may be characterized as 1:1. For example (e.g., in a 1:1 dependency), every source and/or repair packet may generate an enhancement packet. For example, there may exist a (e.g., direct) dependency between the source and/or repair packet and the enhancement packet generated from the source and/or repair packet.

Enhancement dependencies between the source and/or repair data unit and the enhancement data unit may be characterized as 1:1, but not every source and/or repair packet may generate an enhancement packet. For example, a source and/or repair packet may generate an enhancement packet. For example, an enhancement packet may be used to reconstruct the source and/or repair packet the enhancement packet was generated from. For example, an enhancement packet may be used to reconstruct another source and/or repair packet that the enhancement packet was not generated from, e.g., a source and/or repair packet that is adjacent to the source and/or repair packet it was generated from.

Enhancement dependencies between the source and/or repair data unit and the enhancement data unit may be characterized as 1:M. For example, a source and/or repair packet may generate multiple enhancement packets. For example, one or more enhancement packet(s) may be used to reconstruct the source and/or repair packet. For example, multiple enhancement packets may be used to reconstruct the source and/or repair packet.

Enhancement dependencies between the source and/or repair data unit and the enhancement data unit may be characterized as M:1. For example, several source and/or repair packets may be used to generate an enhancement packet. For example, the enhancement packet may be used to reconstruct any one or more of the source and/or repair packet(s) used to generate the enhancement packet.

Dependencies may be visible at the application in the WTRU. Dependency information may be available to the data transmission process in a transmitting device (e.g., a WTRU). For example, the WTRU (e.g., lower layers) may receive an indication of dependencies from the application layer.

Repair PDUs may be generated from the source PDUs, e.g., according to the FEC algorithm. The repair PDUs may help in the detection and/or correction of errors in the traffic stream. Repair PDUs may not be needed by the receiver, for example, if the receiver successfully receives all the source PDUs and they are all uncorrupted. However, if the receiver does not successfully receive any/some/all source PDUs, then the receiver may use the repair PDUs to recover the information that was included in the source PDUs that were not successfully received.

Packetization may be implemented. Applying any FEC algorithm may result in, for example, one or more of the following packetization options: data of different types ending up in different data units (e.g., one data unit including only source packets, another data unit including only repair packets) and/or data of different types ending up in the same data unit (e.g., one data unit including a ratio of two of more data units or type thereof).

A WTRU supporting an XR experience may be receiving data units (e.g., PDUs, PDU sets, data bursts, bitstreams) from higher layers or different devices, such as AR glasses and haptics gloves (e.g., via SL). The data units, which may have variable payload sizes, different periodicity, jitter, and/or different inter-dependencies, may be (e.g., further) processed and transmitted by the WTRU in the UL.

Operations related to capacity may include, for example, one or more of the following: multiple Configured Grant (CG) physical uplink shared channel (PUSCH) transmission occasions in a period of a single CG PUSCH configuration; dynamic indication of unused CG PUSCH occasion(s) based on Uplink Control Information (UCI) by the WTRU; buffer status report (BSR) including buffer status report (BSR) Table(s); delay reporting of buffered data in uplink; and/or discard operation of PDU Sets for UL.

Operations related to power savings may include, for example, one or more of the following: discontinuous reception (DRX) support of XR frame rates corresponding to non-integer periodicities (e.g., through at least semi-static mechanisms, such as RRC signaling).

Operations related to XR awareness may include, for example, one or more of the following: in the downlink, signaling by CN of semi-static information per QoS flow (e.g., PDU set QoS parameters), dynamic information per PDU set (PDU Set information and Identification), and/or End of Data Burst indication, and/or in the uplink, provisioning by WTRU of XR traffic assistance information, e.g., periodicity, UL traffic arrival information.

A Data Volume Calculation may be performed. In example wireless systems, a WTRU may determine the amount of data available for transmission, e.g., for the purpose of MAC buffer status reporting (BSR) and/or for the purpose of MAC delay status reporting (DSR). The WTRU may calculate the RLC data volume and/or the packet data convergence protocol (PDCP) data volume.

The RLC data volume for BSR may include, for example, one or more of the following: RLC SDUs and RLC SDU segments that may not have been included in an RLC data PDU; RLC data PDUs that may be pending for initial transmission; and/or RLC data PDUs that may be pending for retransmission (RLC AM).

The PDCP data volume for BSR may include, for example, one or more of the following: the PDCP service data units (SDUs) for which PDCP Data PDUs may not have been constructed; the PDCP Data PDUs that may not have been submitted to lower layers; the PDCP Control PDUs; for AM DRBs, the PDCP SDUs to be retransmitted; and/or for AM DRBs, the PDCP Data PDUs to be retransmitted.

The combined logic may ensure that a control plane or user plane data unit (e.g., IP packet) is reported once (e.g., not reported twice) for each layer, e.g., as a function of the unit's processing state. The combined logic may (e.g., also) consider that any data that is considered under processing (e.g., by PDCP or RLC) may be reported in the BSR.

The PDCP data volume for DSR may include one or more of the following in a delay-critical PDCP data volume. The transmitting PDCP entity may, for example (e.g., for the purpose of MAC delay status reporting), consider one or more of the following as a delay-critical PDCP data volume: the delay-critical PDCP SDUs for which PDCP Data PDUs may not have been constructed; the PDCP Data PDUs that may include the delay-critical PDCP SDUs that may not have been submitted to lower layers; the PDCP Control PDUs; for AM DRBs, the PDCP SDUs to be retransmitted (e.g., as may be described herein); for AM DRBs, the PDCP Data PDUs to be retransmitted (e.g., as may be described herein).

A PDCP may indicate to a lower layer (e.g., if/when a PDCP SDU becomes delay critical) whether/if a corresponding PDCP Data PDU has been submitted to lower layers.

The RLC data volume for DSR may include, for example, one or more of the following in a delay-critical RLC data volume: delay-critical RLC SDUs and delay-critical RLC SDU segments that may not have been included in an RLC data PDU; RLC data PDUs pending for initial transmission, which may include a delay-critical RLC SDU or a delay-critical RLC SDU segment; RLC data PDUs that may be pending for retransmission (RLC AM).

The combined logic may ensure that the a control plane or user plane data unit (e.g., IP packet) is reported once (e.g., not reported twice) for each layer, e.g., as a function of the unit's processing state and/or contents. The combined logic may (e.g., also) consider that any data that may be considered under processing (e.g., by PDCP or RLC) that may be delay critical may be reported in the DSR. The combined logic may (e.g., also) consider as delay critical data units that may be retransmitted or pending retransmission.

Logical Channel Prioritization may be applied. In some examples, a logical channel prioritization (LCP) procedure may be applied, for example, if/when a new transmission is performed.

A WTRU may determine what data units to multiplex in a transport block for uplink transmission, for example, by (e.g., first) selecting the logical channels applicable to the new transmission according to one or more conditions (e.g., also referred to as “mapping restrictions”), which may include, for example, if data associated with a logical channel can be transmitted with respect to a configured restriction, such as the allowed subcarrier spacing, the PUSCH transmission duration, the type of configured grant, the allowed serving cell, the allowed cell group, the priority index associated to the dynamic UL grant and the allowed hybrid automatic repeat request (HARQ) mode, etc. A WTRU may select the logical channel (LCH) for the next step of the logical channel prioritization (LCP) procedure, for example, if a logical channel's configuration allows associated data be included in the transport block associated with the transmission resources. RRC may control the conditions, for example, by configuration of the MAC parameters, LCH configuration, and/or logical channel group (LCG) configuration.

A WTRU may multiplex data from a selected LCH(s), for example, in decreasing priority order, e.g., where data amount from each LCH may be multiplexed up to their Bj value, which value may be based on the LCH's configured Prioritized Bit Rate (PBR) and/or Bucket Size Duration (BSD). For example, Bj may be equal to PBR multiplied by BSD (e.g., Bj=PBR×BSD). Bj may be decremented by the total size of data multiplexed.

The WTRU may (e.g., if any resource remains) multiplex data from a selected LCH(s) (e.g., in decreasing priority order), regardless of the value Bj, for example, until (e.g., all) the data for the LCH is exhausted or until the resources of the grant are exhausted. LCHs of equal priority may be served equally.

A PDU set may be composed of one or more PDUs carrying the payload of a (e.g., one) unit of information generated at the application level (e.g., a frame or video slice for XRM Services). In some examples, (e.g., all) the PDUs in a PDU Set may be utilized by the application layer to use the corresponding unit of information. In some examples, the application layer may recover one or more parts or all or of the information unit if/when one or more PDUs are missing. For the uplink, the identification of PDU sets, data bursts, and/or PDU Set Importance (PSI) may be left to WTRU implementation.

For a PDU Set in a QoS flow for which the PDU set Integral handling indication (PSIHI) is set, one or more (e.g., all) remaining PDUs of the PDU Set may be discarded at the transmitter (e.g., to free up radio resources), for example, if/when a (e.g., one) PDU of the PDU set is known to be lost or associated with a discarded SDU.

PDU Set Delay Budget (PSDB) may be the time between reception of the first PDU (e.g., at the UPF in DL, at the WTRU in UL) and the successful delivery of the last arrived PDU of a PDU Set (e.g., at the WTRU in DL, at the UPF in UL). PSDB may be an optional parameter. The PSDB (e.g., if/when provided) may supersede the PDB.

The semantics of the fields of the real-time transport protocol (RTP) Header Extension for the marking of PDU Set and End of Bursts in the downlink may be defined, for example, based on one or more of the following: the end PDU of a PDU set [E] may be one bit; an End of Data Burst (EDB) may be three (3) bits; PDU Set Importance (PSI) may be four (4) bits; PDU Set Sequence Number (PSSN) may be ten (10) bits; PDU Sequence Number within a PDU Set (PSN) may be six (6) bits; and/or PDU set size (PSSize) may be 24 bits.

An End PDU of the PDU Set [E] field may be a flag that may be set, for example, to one (1) for the last PDU of the PDU Set and/or set to zero (0) for (e.g., all) other PDUs of the PDU Set.

An End of Data Burst (EDB) field may indicate the end of a Data Burst. The (e.g., 3) bits may encode the End of Data Burst indication, e.g., according to encoding and guidelines as may be described herein.

A PDU Set Importance (PSI) field may indicate the importance of the PDU Set compared to other PDU Sets within the same QoS flow. Lower values may indicate a higher importance PDU Set. For example, the highest importance PDU Set may be indicated by zero (0) and the lowest importance PDU Set may be indicated by a higher number (e.g., 15).

A PDU Set Sequence Number (PSSN) field may encode the sequence number of the PDU Set to which the current PDU belongs (e.g., acting as a (10-bit) numerical identifier for the PDU Set).

A PDU Sequence Number within a PDU Set (PSN) may represent the sequence number of the current PDU within the PDU Set. For example, the PSN may be set to zero (0) for the first PDU in the PDU Set and may be incremented (e.g., monotonically) for every PDU in the PDU set in order of transmission from the sender.

A PDU Set Size (PSSize) may indicate the total size of (e.g., all) PDUs of the PDU Set to which the PDU belongs. The PSSize field may be optional. The PSSize field may be subject to an SDP signaling offer/answer negotiation, for example, where the Application Server may indicate whether it will (e.g., be able to) provide the size of the PDU Set for the RTP stream. If not enabled, the PSSize field may not be present. If enabled, but if the Application Server is not able to determine the PDU Size for a particular PDU Set, the PSSize field may set the value (e.g., to zero (0)) in (e.g., all) PDUs of the PDU Set. The PSSize may indicate the size of a PDU Set, which may include RTP/UDP/IP header encapsulation overhead of corresponding PDUs. The PSSize may be expressed in bytes.

Traffic of applications (e.g., immersive applications, application-level FEC) may include different types of data units with different characteristics, which may be useful to the application in different ways (e.g., mandatory packets, repair packets, and enhancement packets).

Data units (e.g., IP packets, system data such as for sensing) associated with one (or more) service(s) and/or related to a given user experience may have a different impact on the Quality of Experience, for example, as a function of their respective characteristics e.g., type of information, type of coding method, type of data within the encoded stream(s), impact to rendering of video/audio/sensory/spatial dimensions, and/or the like.

QoS may be same within a DRB. In examples of wireless systems, data associated with a radio bearer (RB) e.g., a data radio bearer (DRB) or a signaling radio bearer (SRB), and/or data associated with a PDU set may be processed using the same QoS functions and parameters with the L2 protocol stack e.g., service data adaptation protocol (SDAP), PDCP, RLC, and/or MAC. For example, two different data units or types thereof with the same QoS (e.g., PSDB) may be treated in the same way in the protocol stack, e.g., even if the data units or types of data units serve different purposes to the application.

Data units (e.g., IP packets, L3/RRC messages) associated with the same radio bearer may receive the same QoS treatment (e.g., prioritization, latency, jitter, guaranteed/prioritized bit rate) while QoS differentiation may be implemented by associating data units to different bearers.

A WTRU may determine when and/or what data is available for transmission. In examples of wireless systems, a WTRU may determine the amount of data available for transmission, e.g., for the purpose of buffer status reporting (BSR). A WTRU may determine when, how much, and/or at what layer data is available for transmission. Different vendors may (e.g., retain the flexibility to) determine (e.g., for WTRU implementation) the processing path and/or timing of IP packets (e.g., SDAP SDUs) down to multiplexing data (e.g., MAC PDU) into a transport block scheduled for uplink transmission. For example, WTRUs may (e.g., variously) implement processing/pre-processing of data units in L2 (e.g., PDCP pre-processing) and/or determine how to manage the corresponding buffers.

WTRU implementations may determine that data units (e.g., IP packets) are available for transmission, for example, no earlier than once the data units occupy space in the WTRU's buffer. WTRUs may (e.g., variously) report an associated amount of data transmit, for example, as a function of the processing status of the data unit (e.g., considering PDCP, RLC and/or MAC overhead).

In examples of wireless systems, a WTRU may determine (e.g., or trigger) the transmission of a buffer status report (BSR), a delay status report (D-SR), and/or a scheduling request (SR), for example, as a function of the data becoming available for transmission, an associated transmission delay requirement, and/or an associated priority.

The triggers to initiate SR, BSR, and/or D-SR may be normatively specified, for example, once data is determined to be available for transmission.

One or more features (e.g., as described herein) may be associated with determining when data is considered available for transmission. Described feature(s) may control and implement QoS dependencies between different (e.g., sets of) data units and/or may control relational QoE aspects between the (e.g., sets of) data units. Described feature(s) may optimize the utilization of radio resources, for example, by (e.g., selectively) transmitting data units, e.g., if the data units are determined to be useful to the application. Described feature(s) may adapt the transmission rate in case of congestion, for example, by (e.g., selectively) discarding data units, e.g., if the data units are determined to have lesser impact to the application. Described feature(s) may be useful for applications/services generating redundant information (e.g., AL-FEC) for increased end-to-end reliability and/or for applications/services that can adapt in terms of impact to QoE, transmission rate, and/or error concealment.

In examples of wireless systems, a mechanism may operate on a per-PDU basis (e.g., or per-TB/per-CBG basis at PHY). For example, a mechanism may handle data units jointly (e.g., for BSR, multiplexing) based on an association of the data units to a same radio bearer and/or to a same QoS processing requirement.

Data availability for further L2 processing may be conditioned, e.g., beyond being in the WTRU's buffer.

A WTRU may determine data available for transmission, for example, as a function of a condition and/or as a function of a mapping function between a first set of data and a second set of data. The mapping function may implement a dependency between the (e.g., two) sets of data, such as a base layer versus an enhancement layer (e.g., determined by an encoder and/or a type of media stream), e.g., a source FEC versus a repair FEC (e.g., determined by redundancy and/or reliability encoding), K units within a set of N units (e.g., determined by a minimal threshold within an amount of data), etc. The condition may implement the trigger that the WTRU uses to determine whether data should be considered available for transmission or not. For example, K−1 data units may have been transmitted within “time,” such that the K^{th} unit may also be considered available for transmission. A unit within the N-K units range may be considered available for transmission, for example, if/when a K^{th} unit may not be available in the WTRU's buffer, or if it may not have successfully been transmitted.

A condition may be based on, for example, a transmission status of other data and/or a scheduling data rate.

Upper layers (e.g., SDAP, PDCP, RLC) may indicate to lower layers (e.g., MAC) that new data is available for transmission, for example, based on data being made available as a function of a dependency to another data that may already be available for transmission (e.g., source and repair) and/or the transmission status of the other data (e.g., all source is successful within time or at least one source is missing after a certain time has elapsed).

A WTRU may determine that a second amount of data is available for transmission, for example, as a function of the transmission status of a first amount of data that has previously been multiplexed in a transport block and/or has previously been determined to be available for transmission.

The data availability logic may be performed, for example, in MAC, RLC, and/or PDCP.

A WTRU may use the determination that the second amount of data is available for transmission to implement conditional transmission of the second amount of data, for example, in the case of limited transmission resources (e.g., application-level enhancement layer) and/or in case the second data may provide error correction/error propagation mitigation/error recovery for the application layer (e.g., Application-level FEC repair data).

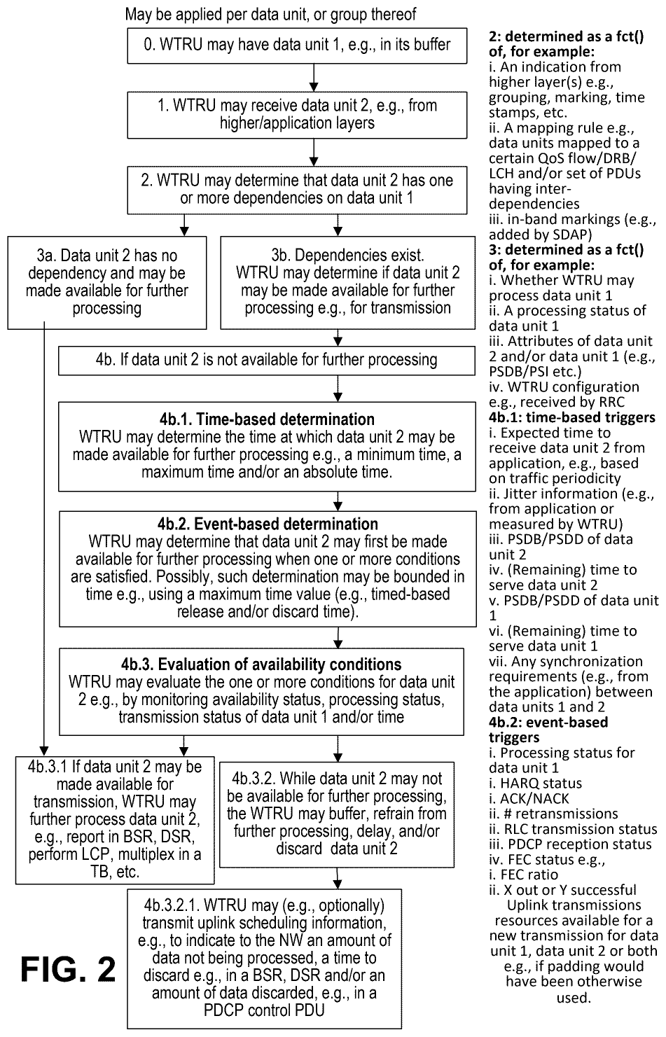

FIG. 2 illustrates an example of determining conditional availability of data for transmission (e.g., applied per data unit or group thereof), where one or more of the illustrated actions may be performed.

At 0, the WTRU may receive an indication of first data (e.g., data unit 1 in FIG. 2). The first data may be in the WTRU's buffer (e.g., for transmission). At 1, the WTRU receive (e.g., from a higher layer, which may be referred to as higher layers herein) an indication of second data. At 2, the WTRU may determine that one or more dependencies exist between the first data and the second data. At 3a, if the second data has no dependency with (e.g., on) the first data, the second data may be made available for further processing. At 3b, the WTRU may determine that a dependency exists between the first data and the second data and, may determine whether the second data is available for further processing. If the second data is not available for further processing at 3b, the WTRU may monitor (e.g., at 4b.3) whether one or more conditions (e.g., time-based condition(s) as disclosed herein and/or event-based conditions(s) as disclosed herein, for example as illustrated at 4b. 1, 4b.2) are met. If the one or more conditions are met, at 4b.3.1, the WTRU may further process the second data and/or transmit the second data. If the one or more conditions are met for a first amount of the second data and not for a second amount of the second data, 4b.3.1 may apply to the first amount of the second data and not to the second amount of the second data. If the one or more conditions are not met (e.g., the second data is not available for further processing and/or transmission), at 4b.3.2 and 4b.3.2.1, the WTRU may buffer, refrain from further processing, delay, and/or discard the second data and/or transmit uplink scheduling information (e.g., in a PDCP control PDU), for example, to indicate to the network an amount of data not being processed, an amount of data being delayed or held (e.g., in the UE buffer), an amount of data discarded, a time to delay or hold the data (e.g., in a BSR, DSR), a reason/justification for delaying, and/or an amount of data discarded, a reason/justification for discarding, identity corresponding to the discarded and/or delayed data (e.g., in terms of sequence numbers).

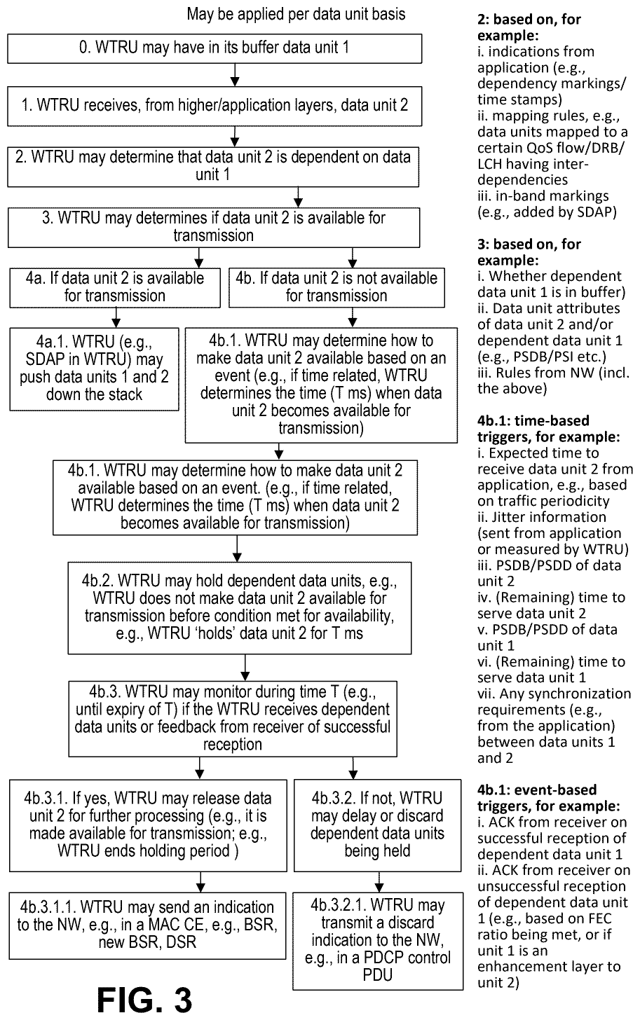

FIG. 3 illustrates an example of determining conditional availability of data for transmission (e.g., applied per data unit or group thereof), where one or more of the illustrated actions may be performed.

At 0, the WTRU may receive an indication of first data (e.g., data unit 1 in FIG. 3). The first data may be in the WTRU's buffer (e.g., for transmission). At 1, the WTRU receive (e.g., from a higher layer, which may be referred to as higher layers herein) an indication of second data. At 2, the WTRU may determine that one or more dependencies exist between the first data and the second data. At 3. The WTRU may determine whether the second data is available for transmission (e.g., based on whether the one or more dependencies exist). At 4a and 4a.1, if the second data is available for transmission, the WTRU may push the first and second data down the stack. At 4b, 4b. 1, and 4b.2, if the second data is not available for transmission, the WTRU may determine to hold the second data based on a time (e.g., a time related to when an event is expected to occur (e.g., a time related to when a condition is expected to be satisfied), for example data reception (e.g., of a dependent data)). The WTRU may, e.g., at 4b. 3, monitor (e.g., during the hold time) whether the event has occurred (e.g., whether the condition has been satisfied). At 4.b.3.1, if the WTRU determines that the event has occurred (e.g., the condition has been satisfied), for example during the time period, the WTRU may further process the second data and/or transmit the second data. At 4b.3.1.1., the WTRU may send an indication to the NW associated with the condition being satisfied and/or the transmission of the second data, e.g., in a MAC CE, e.g., BSR, new BSR, DSR, etc. At 4b.3.2, if the WTRU determines that the event has not occurred (e.g., the condition has not been satisfied), for example during the time period, the WTRU may delay or discard dependent data units being held. At 4b.3.2.1, the WTRU may transmit a discard indication to the NW, e.g., in a PDCP control PDU.

A WTRU may receive and/or determine information on dependencies at the lower layers.

A data unit may include, for example, any one or more of the following: an IP packet and/or a system data unit (e.g., sensing, positioning and/or computing data); a bit and/or group thereof; bytes and/or group thereof; PDU segment and/or group thereof; a PDU; a group/set of PDUs (e.g., PDU set); a set of PDUs that may be considered as one unit at the application, e.g., set of PDUs corresponding to a frame; a group of PDU sets; a data burst; and/or a group of data bursts.

As described herein, a “data unit” may refer to one data unit, a group of data units, a component of a data unit (e.g., a portion of one data unit), and/or a type of data unit (e.g., a group of one or more data units of one type).

In some examples, a data unit may be constructed at the application and sent to the WTRU (e.g., lower layers) as such. In some examples, a data unit may be constructed at the WTRU.

A (e.g., second) data unit may be (e.g., further) characterized, for example, according to at least one of the following: a QoE level, category and/or priority; sequencing information; and/or timing information.

A (e.g., second) data unit may be characterized according to QoE level, category and/or priority. A characterization according to QoE level, category and/or priority may be, for example, an indication of the possible impact of the second data unit to the end-user experience. For example, a higher priority may inform of a higher negative impact if the QoS (e.g., delay, jitter, packet loss rate) is not met for the category. A characterization according to QoE level, category and/or priority may be, for example, an indication that may (e.g., implicitly) be considered as a dependency. For example, a lower priority may inform that the application may tolerate loss, unsuccessful, or no attempt at transmitting the second data unit given that a first data unit of a higher priority may not have been initiated, ongoing, successful, and/or completed.

A (e.g., second) data unit may be characterized according to sequencing information. A characterization according to sequencing information may represent and/or identify a first data unit within a sequence that may be considered as a dependency. For example, the sequencing may inform that the application may tolerate loss, unsuccessful, or no attempt at transmitting the second data unit given that at least one second data unit corresponding to the sequencing information (e.g., equal and/or of earlier position in the sequence) may not have been initiated, ongoing, successful, and/or completed.

A (e.g., second) data unit may be characterized according to timing information. A characterization according to timing information may represent and/or identify a first data unit within a period, a window, and/or a delay bound that may be considered as a dependency. For example, the timing may inform that the application may tolerate loss, unsuccessful, or no attempt at transmitting the second data unit given that at least one second data unit corresponding to the timing information (e.g., earlier in time and/or latency budget) may not have been initiated, ongoing, successful, and/or completed.

There may be IDs/identifiers associated with a data unit and/or component/group/type thereof.

In some examples, the IDs may be allocated by the application.

In some examples, the IDs may be allocated by the WTRU, for example, according to any one or more of the following: using existing identifiers, such as sequence numbering at PDCP; updating existing identifiers, such as sequence numbering at PDCP, to incorporate the concept of data units (e.g., sequence numbering (1,1), (1,2), (1,3) at PDCP referring to packets 1, 2, 3 of data unit 1); using new identifiers allowing the transmitter and receiver to exchange feedback on the data units; the WTRU may receive rules on how to allocate identifiers to the data units and/or identifier or data constituents from the network, e.g., during RRC (re) configuration; and/or the WTRU may receive rules/configuration, e.g., during RRC (re) configuration, on how to translate identifiers for the data units and/or identifier or data constituents that may have been allocated/received (e.g., from a higher/application layer) to an identifier that is understandable to/decodable by the network. For example, a WTRU may receive rules on how to create an identifier. For example, a WTRU may receive a mapping table on how to map an application-created identifier to an identifier that the network understands. For example, a WTRU may receive rules on how to update an identifier.

In some examples, feedback from the network on the successful and/or unsuccessful reception of data unit(s) and/or components thereof may include the identifier of the data units and/or components thereof.

Data units, e.g., as described herein, may refer to a data unit and/or a component/group/type thereof. Data unit(s) may be interchangeably referred to herein as “data.”

A dependent data unit and/or group/component/type thereof, e.g., as described herein, may refer to a data unit and/or group/component/type thereof that may be dependent on another data unit and/or group/component/type thereof or a data unit and/or group/component/type thereof that another data unit and/or group/component/type thereof may be dependent on.

For example, the usefulness of a second data unit, e.g., on the quality of the experience of a given service, may be less (e.g., reduced) if a first data unit is not reliably, timely, and/or previously transmitted.

Data may be grouped as a data unit visible to the WTRU by the application or data may be grouped as a data unit by the WTRU.

In some examples, a data unit may be generated and/or grouped as a (e.g., one) unit of data by the application (e.g., one video frame generated the application) and sent to the WTRU (e.g., lower layers in the WTRU).

In some examples, data may be generated by the application. The WTRU (e.g., SDAP and/or PDCP entity in WTRU) may group the data (e.g., generated by the application) into a data unit. In some examples, the WTRU (e.g., SDAP and/or PDCP entity in WTRU) may see a flow of bits coming in from one or more QoS flows. The WTRU may combine the repair bits into a repair PDU and/or the source bits into a source PDU, which may constitute a data unit. In some examples, the WTRU (e.g., SDAP and/or PDCP entity in WTRU) may combine (e.g., some) source PDUs and corresponding repair PDUs into a (e.g., one) PDU set, which may constitute a data unit. In some examples, the source PDUs assembled/grouped by the WTRU (e.g., SDAP and/or PDCP entity in WTRU) may constitute a primary data unit while the repair PDUs assembled/grouped by the WTRU (e.g., SDAP and/or PDCP entity in WTRU) may constitute a secondary data unit. The WTRU (e.g., SDAP and/or PDCP entity in WTRU) may add markers to the data units that may be read by the receiver (e.g., the gNB) and/or the lower layers in the WTRU (e.g., the MAC entity in the WTRU).

Group of data units (e.g., as described herein) may refer to a group of data units of one type. In some examples, a first group of data unit may refer to a group of mandatory packets while a second group of data units may refer to a group of repair packets. “Data units” (e.g., as described herein) may refer to a group of data units.

Type of data units (e.g., as described herein) may refer to one or more (e.g., any) characteristic of the data unit, e.g., whether attributed by the application and/or the WTRU. Types of data units may include, for example, any one or more of the following: data units associated with a set of QoS parameters, which may include, for example, a type of service, such as a user plane (e.g., IP packets), a control plane (e.g., L3/RRC packets), and/or system data (e.g., sensing, positioning, data collection), a guaranteed bit rate (GBR), a prioritized bit rate (PBR), a transmission delay/latency bound, a transmission jitter bound/range, and/or a packet loss rate (PLR) (e.g., a first type of data units may correspond to a first level of QoS service while a second type of data units may correspond to a second level of QoS service, where the second type of data units may be an enhancement layer of the first type of data units);
repair/source/enhancement data units; primary/secondary/tertiary data units; mandatory/non-mandatory data units; needed for QoS and/or QoE enhancement (e.g., repair data units, enhancement data units); not needed for either QoS or QoE enhancement); needed (e.g., only) for QoS enhancement; needed (e.g., only) for QoE enhancement (e.g., an enhancement data unit); low delay budget data units (e.g., PSDB and/or PDU set delay deadline (PSDD) below a certain/threshold value for PDU set); high delay budget data units (e.g., PSDB and/or PSDD below a value for PDU set); low error rate data units (e.g., PER and/or PDU set error rate (PSER) set below a value for PDU set); high error data units (e.g., PSER above a value for PDU set); data units of an importance value or above; data units of an importance value or below; control plane data units; data units for sensing; data units for positioning; system data units; data units pertaining to RF based systems; data units pertaining to non-RF based systems; data units corresponding to an artificial intelligence (AI)/machine learning (ML) system; user plane data; and/or any of the data as may be described herein (e.g., control plane data, sensing data, positioning data, system data, and so on) that may be used by (e.g., critical for) a user plane service to work.

There may be dependencies at lower layers. A second data unit may be dependent on a first data unit, for example, according to at least one of the following: an explicit signaled, configured, and/or specified association (e.g., related to QoE, QoS, sequencing, and/or timing requirements of the first and second data units, respectively); an implicitly determined association (e.g., related to data types (such as a first data unit associated to base QoE level 1 and a second data unit associated to enhanced QoE level 2) and/or scheduling levels (such as whether transmission resources are equal or above QoE level 1)); and/or a transmission status of the first data unit (e.g., available for transmission, multiplexed in a TB, initial HARQ transmission, HARQ retransmission, HARQ ACK/transmission completed or HARQ transmission failure/maximum number of HARQ retransmission reached).

For example, there may exist dependencies between data units (e.g., dependencies between a source packet and a repair packet generated from the source packet). At the lower layers, e.g., in the protocol stack (e.g., SDAP, PDCP, RLC, MAC PHY), the dependencies may translate and/or be visible via any one or more of the following: an in-band marking (e.g., in the packet header, such as in SDAP subheader, PDCP subheader, etc.); a separate control data unit (e.g., a separate PDCP control PDU may provide information on dependencies between two data PDCP PDUs, such as via the sequence numbering of the dependent PDUs); implicitly via mapping (e.g., dependent data units mapped to the same QoS flow/DRB/LCH, etc.); and/or an explicit relationship between a primary data unit and a secondary data unit created by the WTRU (e.g., SDAP/PDCP) by assembling data (e.g., or type thereof) into different data units. A relationship may be detectable and/or visible, for example, via any one or more of the methods described herein (e.g., in-band marking, control PDU, via mapping, etc.).

The data unit(s) may go through one or more of the following (sub) layer(s) of the protocol stack. At the (sub) layers, dependencies may translate and/or be visible, for example, via any one or more of the following: SDAP, PDCP, RLC, MAC, and/or PHY.

Dependencies may translate and/or be visible via SDAP. For example, data units mapped to the same QoS flow may have dependencies. For example, there may exist dependencies between different QoS flows. The dependent QoS flows may be marked with a dependent marker.

Dependencies may translate and/or be visible via PDCP. For example, data units mapped to the DRB may have dependencies. For example, there may exist dependencies between different PDCP entities/DRBs. For example, a data unit ID indicated in PDCP header.

Dependencies may translate and/or be visible via RLC. In some examples, data units mapped to one RLC entity may have dependencies. In some examples, there may exist dependencies between data units mapped to different RLC entities.

Dependencies may translate and/or be visible via MAC. For example, data units mapped to the same LCH may have dependencies. For example, data units mapped to one or more designated LCHs may have dependencies. For example, a data unit ID may be indicated in a MAC header. For example, the MAC in the WTRU may receive information on dependencies.

Dependencies may translate and/or be visible via PHY. Dependencies may be known/tracked at the PHY sublayer, for example, via any one or more of the following ways: the HARQ process ID mapped to a TB and/or CBG; grants in a multi PUSCH CG; different CG configurations for data units or type/group thereof; a set of resources (e.g., grants, frequency resources) reserved for one data unit or type/group thereof; an ID for the data unit (e.g., PDU set ID); and/or an indicator (e.g., a ‘0’ indicating a repair PDU and a ‘1’ indicating a source PDU).

Dependencies may be known/tracked at the PHY sublayer via the HARQ process ID mapped to a TB and/or CBG. For example, a (e.g., one) TB may include (e.g., only) PDUs of a (e.g., one) data unit. For example, a (e.g., one) CBG may include (e.g., only) PDUs of a (e.g., one) data unit.

Dependencies may be known/tracked at the PHY sublayer via grants in a multi PUSCH CG. For example, (e.g., all) grants in a (e.g., one) CG occasion may include PDUs of a (e.g., one) data unit.

Dependencies may be known/tracked at the PHY sublayer via different CG configurations for data units or type/group thereof. For example, restrictions may allow (e.g., only) source data units to be mapped to the CG grants in a (e.g., one) CG configuration. For example, there may be a (e.g., one) CG configuration for source data units and a (e.g., one) CG configuration for repair data units.

Dependencies may be known/tracked at the PHY sublayer via a set of resources (e.g., grants, frequency resources) reserved for a (e.g., one) data unit or type/group thereof.

Dependencies may be known/tracked at the PHY sublayer via an ID for the data unit (e.g., PDU set ID). For example, there may be a mapping between a (e.g., one) TB and one or more data unit of the same type. For example, there may be a mapping between a (e.g., one) TB and one or more data unit that have inter-dependencies. The WTRU (e.g., PHY sublayer in WTRU) may receive the ID from the MAC sublayer in the WTRU.

Dependencies may be known/tracked at the PHY sublayer via an indicator (e.g., a ‘0’ indicating a repair PDU and a ‘1’ indicating a source PDU). An indicator may be included, for example, in the header of the data unit.

Dependency information at a (e.g., any) sublayer in the protocol stack may be received from a (e.g., any) sublayer above the sublayer. For example, PHY may receive dependency information from MAC. For example, MAC may receive dependency information from RLC, PDCP, and/or SDAP. For example, PDCP may receive dependency information from SDAP and/or upper/application layers.

A WTRU may identify dependencies/association between dependent data units at the PHY layer. In some examples, the PHY layer in a WTRU may use association and/or configuration information to ensure that information about an association between dependent data units is maintained, e.g., if/when mapping and transmitting TBs within the scheduled UL resources. For example, if/when mapping TBs to the scheduled UL resources, the PHY layer in the WTRU may ensure that the receiving entity can identify the dependencies/association between data units included across different TBs. In some examples, the PHY layer may be provided information (e.g., one or more explicit and/or implicit information) and/or indications from higher layer (e.g., MAC layer) regarding TBs that may include associated data units.

The PHY layer in a WTRU may be provided dependency/association information from a higher layer, for example, in one or more of the following ways: HARQ process IDs assigned to TBs that may include dependent/associated data units/PDUs; a resource grant assigned to TBs that may include dependent/associated data units/PDUs; a channel coding scheme assigned to TBs that may include dependent/associated data units/PDUs; and/or an (e.g., explicit) indication that may include dependent/associated data units/PDUs.

A WTRU may be provided dependency/association information via HARQ process IDs assigned to TBs that may include dependent/associated data units/PDUs. For example, the PHY layer in WTRU may be configured to identify TBs assigned with HARQ process ID belonging to one or more sets of HARQ process IDs reserved for TBs that may include associated data units/PDUs.

A WTRU may be provided dependency/association information via a resource grant assigned to TBs that may include dependent/associated data units/PDUs. For example, the PHY layer in WTRU may be configured (e.g., upon receiving an indication, such as via RRC, DCI, of a reserved/special resource grant for transmission (e.g., CG or DG . . . ) to identify that TBs mapped to the reserved/special resource grant are TBs that may include dependent/associated data units/PDUs. The resource mapping reserved for TBs that may include data units/PDUs with dependencies/association may be implemented, for example, in one or more of the following ways: mapping in the frequency domain (e.g., the PHY layer at the WTRU may configured to map TBs that may include dependent data units/PDUs on a reserved bandwidth part (BWP); mapping in the time domain (e.g., the PHY layer at the WTRU may configured to map TBs that may include dependent data units/PDUs on reserved transmission occasions within a multi-PUSCH CG period); and/or mapping in a spatial domain (e.g., the PHY layer at the WTRU may configured to map TBs that may include dependent data units/PDUs on reserved antenna ports).

A WTRU may be provided dependency/association information via a channel coding scheme assigned to TBs that may include dependent/associated data units/PDUs. For example, the PHY layer may receive an indication (e.g., from MAC) to employ a channel coding scheme and/or an error detection scheme (e.g., cyclic redundancy check), which may be (e.g., exclusively) reserved for use on TBs that may include dependent/associated data unites/PDUs.

A WTRU may be provided dependency/association information via an (e.g., explicit) indication that may include dependent/associated data units/PDUs. For example, the PHY layer may be provided with an (e.g., explicit) indication (e.g., via MAC header) on TBs that may include dependent/associated data units.

In some examples, the WTRU (e.g., SDAP/PDCP) may assign different subsets of data units (e.g., source and repair) to separate PDU sets. A WTRU may create a relationship (e.g., an explicit relationship) between the PDU sets, e.g., between a “primary data unit” (e.g., a source data unit) and a secondary data unit (e.g., a secondary data unit). That relationship may become a “restriction” in LCP for the “secondary data unit.” For example, the WTRU may transmit the secondary data unit (e.g., only) if the primary data unit has not been transmitted. For example, the WTRU may transmit the secondary data unit (e.g., only) if the primary data unit has been transmitted. In some examples, there may be a “tertiary data unit,” whose transmission may not necessarily impact the QoS. For example, enhancement data units may be transmitted on a best effort basis (e.g., if resources are available) but the QoS of the associated data unit (e.g., the source data unit that may be enhanced) may not be impacted if any or all of the enhancement data unit is not transmitted, e.g., because the source data unit may be considered as successfully received at the receiver if the source bits/packets of the source data unit are successfully received at the receiver. In some examples, a data unit may include one or more source bits/packets and one or more enhancement bits/packets. The source data unit may be considered as successfully received at the receiver if the source bits/packets of the source data unit are successfully received at the receiver, irrespective of whether any (e.g., all or a portion) of the enhancement bits/packets are transmitted and/or received.

A “primary data unit” may be interchangeably referred to (e.g., herein) as a first data unit. A “secondary data unit” may be interchangeably referred to (e.g., herein) as a second data unit.

A dependent data unit and/or group/component/type thereof (e.g., as described herein) may refer to a data unit and/or group/component/type thereof that may be dependent on another data unit and/or group/component/type thereof or a data unit and/or group/component/type thereof that another data unit and/or group/component/type thereof may be dependent on.

A WTRU may determine dependencies at lower layers. A WTRU may determine what data units to associate together (e.g., the data units to associate to each other, a second data unit to associate to a first data unit, a first data unit to associate to a second data unit, a third data unit to associate to a second and/or first data unit, etc.) based on any one or more of the following: reception of information on AL-FEC at SDAP/PDCP/MAC sublayer from the upper/application layers and/or arrival times of data units in the protocol stack.

A WTRU may determine what data units to associate together based on reception of information on AL-FEC at SDAP/PDCP/MAC sublayer from the upper/application layers.

For example, A WTRU may determine what data units to associate together based on reception of information via the selected QoS flow/DRB/LCH.

For example, a QoS flow may be configured to handle dependencies between data units. The WTRU may assume (e.g., or determine or receive an indication) that (e.g., all) data units associated with a QoS flow have dependencies, e.g., with other data units tagged to the same QoS flow.

For example, there may be dependencies between two or more QoS flows, e.g., dependencies between QoS flow 1 and QoS flow 2. The WTRU may assume (e.g., or determine or receive an indication) that there are dependencies between data units of QoS flow 1 and QoS flow 2. In some examples, the dependencies may be one to one, e.g., data unit 1 of QoS flow 1 may be dependent on data unit 1 of QoS flow 2 and/or data unit 2 of QoS flow 1 may be dependent on data unit 2 of QoS flow 2. In some examples, the dependencies may be many to one or one to many. For example, data units 1 and 2 of QoS flow 1 may be dependent on data unit 1 of QoS flow 2 and/or data units 3 and 4 of QoS flow 1 may be dependent on data unit 2 of QoS flow 2. For example, data units 1 and 2 of QoS flow 2 may be dependent on data unit 1 of QoS flow 1 and/or data units 3 and 4 of QoS flow 2 may be dependent on data unit 1 of QoS flow 2.

For example, a radio bearer may be configured to handle dependencies between data units. For example, one or more DRB(s) may be configured to handle dependencies between data units.

In some examples, a WTRU (e.g., SDAP in WTRU) may tag (e.g., all) dependent data units (e.g., from one or more QoS flows) to the one or more DRBs that may be configured to handle dependencies.

In some examples, (e.g., only) dependent data units may be mapped to the one or more DRBs that may be configured to handle dependencies.

In some examples, dependent data units may be mapped to the one or more DRBs that may be configured to handle dependencies. Other data units (e.g., non-dependent data units) may (e.g., also) be mapped to the same DRB(s).

For example, a DRB (e.g., DRB A) may be configured for data units mapped to a (e.g., one) QoS flow (e.g., QoS flow A) and another DRB (e.g., DRB B) may be configured for data units mapped to another QoS flow (e.g., QoS flow B). The dependencies (e.g., if there are dependencies between QoS flow A and QoS flow B) may be maintained via an association between DRB A and DRB B. For example, a WTRU may receive (e.g., from the NW) information on dependencies between DRB A and DRB B. For example, dependency information may indicate that (e.g., only) data units from QoS flow A may be mapped to DRB A. For example, dependency information may indicate that (e.g., only) data units from QoS flow B may be mapped to DRB B. For example, dependency information may indicate that (e.g., only) data units from QoS flow A with a certain QoS profile (e.g., delay budget, delay deadline, error rate, PDB, PER, PSDB, PSER) may be mapped to DRB A. For example, dependency information may indicate that (e.g., only) data units from QoS flow B with a certain QoS profile (e.g., delay budget, delay deadline, error rate, PDB, PER, PSDB, PSER) may be mapped to DRB B. For example, dependency information may indicate that the data units from QoS flow A with dependencies with other data units from QoS flow A may be mapped to DRB A. For example, dependency information may indicate that the data units from QoS flow A with dependencies with data units from QoS flow B may be mapped to DRB A.

For example, DRBs configured to handle dependencies and/or dependencies between DRBs may be handled via identifiers. For example, the WTRU may receive from the NW an indication that DRB 1 is configured to handle dependencies. For example, the WTRU may receive from the NW an indication that DRB 1 is configured for data units corresponding to a video flow and DRB 2 is configured for data units corresponding to an audio flow wherein there are dependencies between the video flow and the audio flow that have to be met, e.g., in terms of a synchronization requirement between the video flow and the audio flow that needs to be met, e.g., the synchronization window is not to be exceeded. The WTRU may map (e.g., only map) data units of a video flow and audio flow to DRB 1 and DRB 2 respectively if there are dependencies between the video flow and the audio flow (e.g., synchronization window not to be exceeded).

For example, a radio bearer may be configured to assume that (e.g., all) data units tagged to a QoS flow have dependencies, e.g., with other data units tagged to the same QoS flow.

In some examples, a WTRU may determine what data units to associate together based on reception of information (e.g., explicitly) via in-band marking (e.g., in packet header).

In some examples, a WTRU may determine what data units to associate together based on reception of information (e.g., explicitly) via separate PDU, e.g., PDCP control PDU conveying dependency info via a sequence number (SN).

A WTRU may determine what data units to associate together based on arrival times of data units in the protocol stack.

A WTRU may group data units. A WTRU may group data units, for example, based on information on dependencies (e.g., received from application or determined by the WTRU). A WTRU (e.g., SDAP/PDCP) may assign different subsets of data (e.g., source and repair packets) to separate data units and/or may create an explicit relationship between the data units, e.g., between a primary data unit (e.g., a source data unit) and a secondary data unit (e.g., a secondary data unit).

A relationship may include a framework. For example, a (e.g., one) data unit or type thereof may be carried in one transport vessel/path and another data unit or type thereof may be carried in another transport vessel/path. The transport vessel may refer, for example, to any one or more of the following: QoS flow (e.g., one QoS flow per data unit and/or type/group/component thereof); Radio bearer (e.g., one DRB per data unit and/or type/group/component thereof); Logical Channel Group (LCG) (e.g., one LCG per data unit and/or type/group/component thereof); Logical channel (LCH) (e.g., one LCH per data unit and/or type/group/component thereof); RLC entity (e.g., one RLC entity processing per data unit and/or type/group/component thereof); and/or A (e.g., new) transport vessel (e.g., a construct used in the L2 stack such that (e.g., all) data units and/or type/group/component thereof mapped/tagged to the transport vessel may be considered to have an association.

There may be condition(s) for when data may become available for transmission.

A WTRU may conditionally determine that a second data unit may be available for further L2 processing. Data may be available for transmission, for example, according to at least one of the following: the WTRU determines that the second data unit has no dependency and/or condition for availability for transmission; and/or the WTRU determines that the second data unit has a dependency and/or a condition to a first data unit, and the condition for availability for transmission has been met. For example, a WTRU may determine that a data unit earlier in the same media encoding sequence may have been multiplexed in a transport block for transmission. For example, a WTRU may determine that a data unit with a higher QoE impact and with an earlier transmission delay bound may have been multiplexed in a transport block for transmission. For example, a WTRU may determine that a data unit associated with a base QoS level may have been multiplexed in a transport block for transmission. The WTRU may determine that uplink transmission resources may have been or are being scheduled at a level beyond that of the base QoS level.

A WTRU may conditionally determine that a second data unit may be available for further processing, for example, based on a configuration of data units, association to a data type, configuration of a dependency to other data units/types, and/or evaluation of the applicable condition, e.g., if/when new data arrives in the WTRU's buffer, if/when new uplink transmission resources are scheduled/available, and/or if/when uplink scheduling information is triggered and/or reported.

Data may “become available for transmission.” The definition of becoming available for transmission may be different, for example, based on the type of packetization, e.g., whether data of different types ended up in the same data unit (e.g., described herein as example CASE 1) or whether data of different types ended up in different data units (e.g., described herein as example CASE 2).

In example CASE 1 (e.g., if different types of data end up in the same data units), a data unit becoming available for transmission may depend on the WTRU receiving the entire/complete data unit and/or a percentage thereof.

In example CASE 2 (e.g., if different types of data end up in different data units), a data unit becoming available for transmission may depend on when a (e.g., any) dependent data unit (e.g., also) becomes available for transmission.

Condition(s) for when data becomes available for transmission may include, for example, one or more of the following: based on status of data unit and/or group/component/type thereof (e.g., for example CASE 1); if a configured amount/percentage of the data unit and/or group/component/type thereof is received at the WTRU (e.g., from the higher/application layers); if data unit and/or group/component/type thereof is successfully received at the receiver; after a certain timing condition(s) is met or not met; and/or after one or more condition is met or not met.

Condition(s) for when data becomes available for transmission may include a status of a data unit and/or group/component/type thereof (e.g., for CASE 1).

For example, data may be conditionally available for transmission if a data unit (e.g., an entire data unit) and/or group/component/type thereof is received at the WTRU, e.g., from the higher/application layers. The condition may be satisfied, for example, if 100% of the data unit is received at the WTRU and/or if 100% of the constituent source packets of the data unit are received at the WTRU.

For example, data may be conditionally available for transmission if a configured amount/percentage of the data unit and/or group/component/type thereof is received at the WTRU, e.g., from the higher/application layers. The condition may be satisfied, for example, if 80% of the entire data unit is received at the WTRU and/or if 90% of the constituent source packets of the data unit are received at the WTRU.

For example, data may be conditionally available for transmission if a data unit and/or group/component/type thereof is successfully received at the receiver. For example, data may be conditionally available for transmission if 100% of the data unit is received at the receiver and the corresponding acknowledgement for the data units are (e.g., also) received at the receiver, e.g., HARQ ACK, RLC AM reports, and/or PDCP status reports with the sequence number(s) of the data unit and/or group/component/type thereof. In some examples, the WTRU may receive a negative acknowledgement for any unsuccessfully received data unit and/or group/component/type thereof instead (e.g., HARQ NACK or request for retransmission at RLC and/or PDCP). For example, data may be conditionally available for transmission if 100% of the constituent source packets of the data unit are received at the receiver and the corresponding acknowledgement for the source packets are (e.g., also) received at the receiver, e.g., HARQ ACK, RLC AM reports, and/or PDCP status reports with the sequence number(s) of the source packets and/or group/component/type thereof.

For example, data may be conditionally available for transmission based on whether (e.g., after) a certain timing condition(s) is met or not met. For example, data may be conditionally available for transmission after a (pre) configured time has elapsed since the data unit was generated by the application. For example, data may be conditionally available for transmission after a (pre) configured time has elapsed since the WTRU received the data unit, e.g., at any of the L2 buffers, such as the SDAP buffer, PDCP buffer, MAC buffer, and/or other (e.g., new layer) buffer. For example, data may be conditionally available for transmission after a (pre) configured time has elapsed since the data unit was processed/pre-processed/post-processed at the WTRU, e.g., at any of the L2 buffers, such as since a time has elapsed after the sequence numbering has been generated and allocated to the data unit at the PDCP layer.

For example, data may be conditionally available for transmission based on whether (e.g., after) one or more condition(s) is met or not met. For example, a WTRU may determine that data may be conditionally available for transmission if the data unit type is equal to the source packet and a certain preconfigured time has elapsed. For example, data may be conditionally available for transmission if (e.g., all) source data units may be considered available for transmission after a preconfigured time has elapsed. For example, data may be conditionally available for transmission if 80% of source data units may be considered available for transmission after a preconfigured time has elapsed. For example, data may be conditionally available for transmission if at least one source data unit is missing after a (pre) configured time has elapsed.

Conditions for when data becomes available for transmission may include a transmission status of a dependent data unit and/or group/component/type thereof, e.g., for CASE 2, which may include any one or more condition(s) (e.g., as described herein) being met or not met applied to a dependent data unit and/or group/component/type thereof. Data may be available for transmission, for example, based on any one or more of the following examples.

For example, data may be conditionally available for transmission if a dependent data unit and/or a group/component/type thereof has become available for transmission.

For example, data may be conditionally available for transmission if a dependent data unit and/or a group/component/type thereof has not become available for transmission.

For example, data may be conditionally available for transmission if a dependent data unit and/or a group/component/type thereof have already been transmitted.

For example, data may be conditionally available for transmission if a dependent data unit and/or a group/component/type thereof has not been transmitted.

For example, data may be conditionally available for transmission if a dependent data unit and/or a group/component/type thereof has been multiplexed into a MAC PDU.

For example, data may be conditionally available for transmission if dependent data unit and/or a group/component/type thereof has not been multiplexed into a MAC PDU.

For example, data may be conditionally available for transmission if a dependent data unit and/or group/component/type thereof is in any of L2 buffer (e.g., PDCP/RLC/MAC/new layer buffer).

For example, data may be conditionally available for transmission if a dependent data unit and/or a group/component/type thereof is not in any L2 buffer (e.g., PDCP/RLC/MAC/new layer buffer).

For example, data may be conditionally available for transmission if a configured amount/percentage of dependent data unit and/or group/component/type thereof is received at the WTRU, e.g., from the higher/application layers.

For example, data may be conditionally available for transmission if an amount/volume less than or equal to a configured amount/volume/percentage of the entire dependent data unit and/or group/component/type thereof is received at the WTRU, e.g., from the higher/application layers.

For example, data may be conditionally available for transmission if an amount/volume more than or equal to a configured amount/volume/percentage of the entire dependent data unit and/or group/component/type thereof is received at the WTRU, e.g., from the higher/application layers.

For example, data may be conditionally available for transmission if a dependent data unit and/or a group/component/type thereof is successfully received at the receiver. For example, data may be conditionally available for transmission if 100% of the data unit is received at the receiver and the corresponding acknowledgement for the data units are (e.g., also) received at the receiver, e.g., in terms of the WTRU receiving HARQ ACK, RLC AM reports, and/or PDCP status reports with the sequence number(s) of the data unit and/or group/component/type thereof.

For example, data may be conditionally available for transmission if a dependent data unit and/or a group/component/type thereof is not successfully received at the receiver (e.g., gNB). For example, data may be conditionally available for transmission based on reception at the WTRU of a negative acknowledgement from the receiver (e.g., HARQ NACK). For example, data may be conditionally available for transmission based on no reception at the WTRU of a positive acknowledgement from the receiver within a certain time window of the WTRU transmitting the dependent data unit (e.g., no reception of PDCP status report within a time window). For example, data may be conditionally available for transmission if an amount/volume less than a configured amount/volume/percentage of the entire data unit is received at the receiver. For example, data may be conditionally available for transmission if the number of positive acknowledgements received by the WTRU, e.g., within a (pre) configured time window, from the receiver is less than a certain number (e.g., number of HARQ ACKs, number of PDCP status reports). For example, data may be conditionally available for transmission if the number of negative acknowledgements received by the WTRU, e.g., within a (pre) configured time window, from the receiver is greater than a (e.g., configured, determined, selected, threshold, certain) number (e.g., number of HARQ NACKs).

For example, data may be conditionally available for transmission after a certain timing condition(s) is met or not met.

For example, data may be conditionally available for transmission after one or more condition(s) (e.g., related to time, data unit type, and/or data unit reception status) associated with the one or more or (e.g., all) dependent data units is met or not met. For example, data may be conditionally available for transmission after a (e.g., certain) time has elapsed since dependent data unit has fulfilled one of more condition(s), e.g., any one or more of the condition(s) described herein. For example, data may be conditionally available for transmission after a (pre) configured time has elapsed since the WTRU received one or more or (e.g., all) dependent data units, e.g., at any of the L2 buffer, e.g., SDAP buffer, PDCP buffer, MAC buffer, new layer buffer, etc. For example, data may be conditionally available for transmission after a (pre) configured time has elapsed since the one or more (e.g., all) data units was processed/pre-processed/post-processed at the WTRU, e.g., at any of the L2 buffers. For example, data may be available for transmission after a (e.g., certain) time has elapsed after the sequence numbering has been generated and allocated to the dependent data unit(s) at the PDCP layer. For example, a data unit may be available for transmission if a dependent data unit type is equal to a source packet and a (pre) configured time has elapsed. For example, data may be conditionally available for transmission if (e.g., all) dependent source data units may be considered available for transmission after a (pre) configured time has elapsed. For example, data may be conditionally available for transmission if 80% of dependent source data units may be considered available for transmission after a (pre) configured time has elapsed. For example, data may be conditionally available for transmission if at least one dependent source data unit is missing after a (pre) configured time has elapsed.

For example, data may be conditionally available for transmission if an amount/volume (e.g., a certain amount/volume) of a dependent data unit has been transmitted (N out of K PDUs of PDU set).

For example, data may be conditionally available for transmission if a WTRU has received feedback from a NW on successful reception of a dependent data unit.

For example, data may be conditionally available for transmission based on information on previous transmissions. For example, data may be conditionally available for transmission if repair data units are mapped to a (e.g., one) QoS flow and source data units are mapped to another QoS flow. For example, the WTRU may have information on when repair data unit R2 may become available for transmission based on when repair data unit R1 became available in a previous transmission.

Conditions for when data becomes available for transmission may include the WTRU determining that a data unit and/or group/component/type thereof has become available for transmission, for example, according to a set of rules received from the network, which may pertain to the data unit itself and/or group/component/type thereof and/or another data unit and/or group/component/type thereof with an association to the data unit and/or group/component/type thereof. The rules may be received by the WTRU from the NW, for example, in an RRC (re) configuration. Rules from a network may be based on any one or more condition(s), e.g., as described herein, which may include dependencies between data units and/or group/component/type thereof.

In some examples, data becoming “available for transmission” may signify data and/or dependent data becoming available to the MAC entity in the WTRU.

A dependent data unit and/or group/component/type thereof, e.g., as described herein, may refer to a data unit and/or group/component/type thereof that may be dependent on another data unit and/or group/component/type thereof or a data unit and/or group/component/type thereof that another data unit and/or group/component/type thereof may be dependent on.

A WTRU may hold data until availability for transmission condition(s) is met. As described herein, “hold” may be interpreted as the WTRU determining that a data unit in the WTRU's buffer may not be further processed by (e.g., L2) until a condition is met. A determination by the WTRU may be performed in different protocol layer and/or sublayer e.g., in SDAP, PDCP, RLC, and/or in MAC. For a given data unit, one or more conditions may be applicable. Multiple conditions may be determined in the same protocol layer and/or in different protocol layers.

For example, a second data unit may be conditionally available for transmission if the WTRU determines (e.g., in SDAP) that there is a dependency on the successful transmission of a first data unit and if the WTRU determines (e.g., in MAC) that the amount of scheduled uplink resources is above a (e.g., configured) QoS-level.

For example, the WTRU may hold the data at any one or more of the L2 sublayers (e.g., SDAP, PDCP, RLC, MAC, new sublayer) until any one or more of the conditions for data becoming available for transmission (e.g., as described herein) is met.

In some examples, holding of data may be at SDAP. For example, the SDAP may determine whether there are dependencies between data units. If there are no dependencies, the SDAP may transmit the data units down the stack for (e.g., further) processing. If there are dependencies, the SDAP may hold data units until the dependent data units are received at the SDAP before sending them down the stack. The processing at SDAP may (e.g., also) be different, for example, based on the data availability condition(s) being met or not. For example, data units that have met the data availability condition(s) may be tagged to one or more designated DRBs by the SDAP while data units not having met the data availability condition(s) (e.g., due to a dependent data unit not available for transmission) may be tagged to another one or more DRBs.

In some examples, holding of data may be at PDCP, e.g., as part of PDCP pre-processing. For example, PDCP may receive information on dependencies from higher layers (e.g., application layer and/or SDAP). For example, if there are no dependencies between the data units, the PDCP may process the data units and transmit them down the stack. If there are dependencies, the PDCP may hold data units until the dependent data units are received at the PDCP before doing the processing. The processing may (e.g., also) be different for dependent data units at the PDCP, for example, based on one or more of the following: allocation of sequence numbering at the PDCP taking into account whether the data availability condition(s) of the data unit is met or not; allocation of associated sequence numbers at the PDCP for dependent data units; discard condition(s) at PDCP taking into account whether the data availability condition(s) of the data unit is met or not.

In some examples, holding of data may be at the MAC sublayer. For example, MAC may receive information on data availability condition(s) and/or dependencies from higher/application layers. If there are no dependencies between the data units and/or no data availability condition(s) to be met, the MAC may perform multiplexing of the data units into the MAC PDU by considering the QoS of the data units (e.g., priority). If there are dependencies, the MAC may hold data units until the dependent data units are received and/or until the data availability condition(s) is met before multiplexing the data unit into a MAC PDU.

In some examples, holding of data may be at a (e.g., new) sublayer. For example, a (e.g., any) function of the (e.g., new) sublayer (e.g., as well as routing from the sublayer to another sublayer) may be based on a data availability condition(s) being met or not.

For example, data being made available for transmission may be based on conditions at one or more sublayers being met. For example, a second data unit may be conditionally available for transmission if the WTRU determines (e.g., in SDAP) that there is a dependency on the successful transmission of a first data unit and if the WTRU receives feedback of successful reception of the first data unit at another sublayer (e.g., HARQ feedback at MAC sublayer). For example, a second data unit may be conditionally available for transmission if the WTRU determines (e.g., in SDAP) that there is a dependency on the successful transmission of a first data unit and if the WTRU determines (e.g., in MAC) that it may have sufficient resources to schedule the second data unit. For example, a second data unit may be conditionally available for transmission if the WTRU determines (e.g., in SDAP) that there is a dependency on the successful transmission of a first data unit and if the WTRU determines (e.g., in MAC) that it may have sufficient resources to schedule both the first and the second data unit.

A WTRU may determine a time duration T to hold a data unit.

A WTRU may determine a time duration T to hold a data unit, for example, based on a discardTimer value of a data unit and/or a dependent data unit.

A WTRU may determine a time duration T to hold a data unit, for example, based on a remaining time of a data unit and/or a dependent data unit.

For example, the remaining time of a data unit and/or a dependent data unit may be determined based on the discardTimer at PDCP.

For example, the remaining time of a data unit and/or a dependent data unit may be determined based on the remaining time to serve the data unit and/or dependent data unit. The remaining time to serve the data unit and/or dependent data unit may be based on metrics, such as the delay budget associated with the data unit (e.g., PSDB, PSDD). The remaining time to serve the data unit and/or dependent data unit may be based on the time the data unit and/or dependent data unit may be expected to spend in the L2 buffers. The time the data unit and/or dependent data unit may be expected to spend in the L2 buffers may be the total time the data unit and/or dependent data unit may be expected to spend in the L2 buffers. The time the data unit and/or dependent data unit may be expected to spend in the L2 buffers may be the remaining time the data unit and/or dependent data unit may be expected to spend in the L2 buffers. For example, if the data unit and/or dependent data unit is currently in the PDCP buffer, the remaining time the data unit and/or dependent data unit may be expected to spend in the L2 buffers may be the time the data unit and/or dependent data unit may be expected to spend in the remaining L2 buffers (e.g., RLC, MAC).

A WTRU may determine a time duration T to hold a data unit, for example, based on an expected time to receive a data unit of a component thereof from the application, e.g., based on traffic periodicity.

A WTRU may determine a time duration T to hold a data unit, for example, based on an expected time to receive a data unit of component thereof from application, e.g., jitter information. For example, jitter may be sent to the WTRU from the application. For example, jitter may be measured by the WTRU, e.g., based on the differential between when the WTRU expects the data unit or group/component thereof to arrive in the WTRU buffer (e.g., based on information, such as traffic periodicity, from the application) and when the data unit (e.g., or component thereof) actually arrives in the WTRU buffer.

A WTRU may determine a time duration T to hold a data unit, for example, based on one or more (e.g., any) synchronization requirements (e.g., from the application) between (e.g., two) dependent data units or group/type/component thereof.

A WTRU may determine a time duration T to hold a data unit, for example, based on one or more (e.g., any) parameters (e.g., as described herein) for a dependent data unit or component thereof.

A WTRU may determine a time duration T to hold a data unit, for example, based on when the WTRU may expect a data unit and/or a dependent data unit to become available for transmission, which may be based on, for example, one or more of the following: information on UL traffic periodicity and/or UL jitter and/or information on previous transmissions. For example, the WTRU may collect information in previous transmissions, e.g., per QoS flow, per DRB, per LCH, per data type, and/or per QoS class of data, etc. For example, the WTRU may determine that data units from a (e.g., particular) QoS flow and/or DRB tend to become available after X ms from previous handling of data units from the (e.g., particular) QoS flow and/or DRB.

In some examples, a WTRU may monitor for a time (e.g., T ms) to determine if the WTRU receives a dependent data unit and/or component thereof and/or a first data unit on which other data units may have dependencies on. The WTRU may release a data unit for further processing after expiry of a timer, e.g., corresponding to a length of T ms.

A WTRU may release a data unit for further processing. A WTRU (e.g., any sublayer in the WTRU) may release a data unit for further processing, which may include multiplexing in a MAX PDU or discarding. A WTRU may release a data unit for further processing, for example, based on one or more of the following: after expiry of a timer corresponding to a length of T ms, the time to hold a data unit; after start and/or expiry of a timer associated with a dependent data unit; after receiving an indication from an application (e.g., data unit no longer needed by application and/or FEC ratio has been met); after receiving a feedback from the network (e.g., a HARQ ACK/NACK for a dependent data unit, a HARQ ACK/NACK for a previous transmission of the data unit, after receiving a PDCP status report from the NW indicating successful reception of data unit at the NW, after receiving an RLC AM report indicating successful reception of the data unit at the NW); and/or after receiving a feedback from any of the L2 sublayer/processes (e.g., RLC may release a data for further processing following a discard indication from the PDCP sublayer).

WTRU processing may be based on data availability condition(s).

Routing is an example of WTRU processing that may be based on data availability condition(s). As described herein, “routing” may be interpreted as the WTRU determining that a data unit in the WTRU's buffer may be processed by a (e.g., specific) protocol and/or sublayer.

At a (e.g., any) sublayer, routing may be based on data availability for transmission condition(s) being met or not. For example, if a (e.g., any) sublayer and/or entity (e.g., SDAP) determines there are dependencies between data units 1 and 2, the sublayer and/or entity (e.g., SDAP) may release (e.g., only) data unit 1 after successfully receiving data unit 2 from the higher/application layer.

A (e.g., any) sublayer and/or entity (e.g., PDCP) may map (e.g., only) data available for transmission to another sublayer and/or entity (e.g., RLC entity and/or logical channel and/or logical channel group). For example, data not available for transmission may be held until the data availability condition(s) is met (e.g., in which case the data may be routed to the relevant RLC entity) or the data availability condition(s) is not met (e.g., in which case the data may be discarded).

A (e.g., any) sublayer and/or entity may perform a function and/or processing (e.g., only) on data that has become available for transmission. For example, at MAC, the WTRU may perform Logical Channel Prioritization (LCP) (e.g., only) on data that has become available for transmission.

Discarding is an example of WTRU processing that may be based on data availability condition(s).

For example, data unit 2 may not be made available for further L2 processing and/or may not be made available for transmission within a specific amount of time. For example, the WTRU may determine that data unit 2 is available in the WTRU's buffer, may start a timer that may implement a discard function (e.g., the WTRU may discard, remove a data unit from the buffer upon expiry of an associated discard timer), may determine that data unit 2 is (e.g., only) conditionally available for transmission, and may determine that the data unit's discard time has expired before determining that the condition for data unit 2 to become available for transmission is met, in which case, the WTRU may discard data unit 2, e.g., without data unit 2 triggering an SR, BSR, D-SR and/or without reporting an associated data amount in uplink scheduling information.

For example, the discard condition(s) in the WTRU (e.g., at PDCP) may take into account the availability of data for transmission.

For example, the WTRU (e.g., PDCP) may discard any data units and/or component thereof if the WTRU does not receive the entire data unit in the WTRU's buffer (e.g., from the higher/application later) within a time T ms.

For example, the WTRU (e.g., PDCP) may discard any data units and/or component thereof if the WTRU does not receive feedback from a receiver (e.g., gNB) of successful reception of the entire data unit or part thereof within a time T ms.

For example, the WTRU (e.g., PDCP) may discard any data units and/or group/type/component thereof if the WTRU does not receive a dependent data unit in the WTRU's buffer (e.g., from the higher/application later) within a time T ms.

For example, the WTRU (e.g., PDCP) may discard any data units and/or group/type/component thereof if the WTRU does not receive feedback from a receiver (e.g., gNB) of successful reception of a dependent data unit and/or group/type/component thereof within a time T ms.

The discard condition(s) in the WTRU (e.g., at PDCP) may take into account the availability of data for transmission, e.g., instead of other parameters, such as a discardTimer value. In examples, the WTRU may perform discarding, for example, if/when the described condition is fulfilled, e.g., regardless of whether the corresponding discardTimer may still be running or has expired.

The discard condition(s) in the WTRU (e.g., at PDCP) may take into account the availability of data for transmission, e.g., in addition to other parameters, such as an AL-FEC ratio. In examples, the WTRU may not perform discarding, for example, if the FEC ratio is not met.

A WTRU may report to the NW on discarded data units, for example, following the discard, e.g., based on the availability of data for transmission condition(s). For example, the WTRU may include in a report (e.g., PDCP status report, PDCP control PDU, etc.) any one or more of the following: the identity of discarded data (e.g., sequence number of discarded packets, ID of data units, and/or a part/component thereof); and/or a reason for discarding (e.g., data not available for transmission, dependent data not available for transmission).

A PDCP may consider data available for transmission. The transmitting PDCP may consider (e.g., for the purpose of MAC buffer status reporting) data available for transmission (e.g., only data available for transmission) as part of the PDCP data volume calculation, which may include a subset or all of the data considered for PDCP data volume calculation.

Data considered for PDCP data volume calculation may include, for example, one or more of the following: the PDCP SDUs for which no PDCP Data PDUs have been constructed; the PDCP Data PDUs that have not been submitted to lower layers; the PDCP Control PDUs; for AM DRBs, the PDCP SDUs to be retransmitted; and/or for AM DRBs, the PDCP Data PDUs to be retransmitted.

The transmitting PDCP may consider data available for transmission (e.g., as part of the PDCP data volume calculation) based on a timer (e.g., discardTimer at PDCP) associated with any one or more of the data units and/or group and/or component thereof (e.g., as described herein). In some examples, there may be one timer configured per PDCP SDU. In some examples, there may be one timer configured per data unit, group, and/or component thereof (e.g., one timer per PDU set).

A WTRU may consider, for example, any one or more of the following data as “available for transmission”: the PDCP SDUs for which PDCP Data PDUs may not have been constructed; the PDCP SDUs for which PDCP Data PDUs may not have been constructed and whose corresponding at least one timer (e.g., PDCP discardTimer associated with the data unit and/or component and/or group thereof) has been triggered; the PDCP SDUs for which PDCP Data PDUs may not have been constructed and whose corresponding at least one timer (e.g., PDCP discardTimer associated with the data unit, component, and/or group thereof) may have had a configured amount of time elapsed (e.g., 50% of time elapsed on timer); the PDCP Data PDUs that may not have been submitted to lower layers and may have a dependent data unit that has arrived in the WTRU buffer (e.g., PDCP buffer, SDAP buffer, any L2 buffer); the PDCP SDUs for which PDCP Data PDUs may not have been constructed and where the at least one timer associated with a dependent data unit may have been triggered; the PDCP SDUs for which PDCP Data PDUs may not have been constructed and where the at least one timer associated with a dependent data unit may have had a configured amount of time elapsed (e.g., 50% of time elapsed on timer); the PDCP Data PDUs that may not have been submitted to lower layers; the PDCP Data PDUs that may not have been submitted to lower layers and whose corresponding at least one timer (e.g., PDCP discardTimer for a data unit and/or component/group thereof) may have been triggered; the PDCP Data PDUs that may not have been submitted to lower layers and whose corresponding at least one timer (e.g., PDCP discardTimer associated with the data unit, component, and/or group thereof) may have had a configured amount of time elapsed (e.g., 50% of time elapsed on timer); the PDCP Data PDUs that may not have been submitted to lower layers and may have a dependent data unit that is in the WTRU buffer (e.g., PDCP buffer, SDAP buffer, any L2 buffer); the PDCP Data PDUs that may not have been submitted to lower layers and where the at least one timer associated with a dependent data unit may have been triggered; the PDCP Data PDUs that may not have been submitted to lower layers and where the at least one timer associated with a dependent data unit may have had a configured amount of time elapsed (e.g., 50% of time elapsed on timer); the PDCP control PDUs; the PDCP control PDUs whose corresponding at least one timer (e.g., PDCP discardTimer for a data unit and/or component/group thereof) may have been triggered; the PDCP control PDUs whose corresponding at least one timer (e.g., PDCP discardTimer associated to the data unit and/or component and/or group thereof) may have had a configured amount of time elapsed (e.g., 50% of time elapsed on timer); the PDCP control PDUs that may have a dependent data unit that is in the WTRU buffer (e.g., PDCP buffer, SDAP buffer, any L2 buffer); the PDCP control PDUs where the at least one timer associated with a dependent data unit may have been triggered; the PDCP control PDUs where the at least one timer associated with a dependent data unit may have had a configured amount of time elapsed (e.g., 50% of time elapsed on timer); for AM DRBs, the PDCP SDUs to be retransmitted; for AM DRBs, the PDCP SDUs to be retransmitted whose corresponding at least one timer (e.g., PDCP discardTimer for a data unit and/or component/group thereof) may have been triggered; for AM DRBs, the PDCP SDUs to be retransmitted whose corresponding at least one timer (e.g., PDCP discardTimer associated with the data unit, component, and/or group thereof) may have had a configured amount of time elapsed (e.g., 50% of time elapsed on timer); for AM DRBs, the PDCP SDUs to be retransmitted that may have a dependent data unit that is in the WTRU buffer (e.g., PDCP buffer, SDAP buffer, any L2 buffer); for AM DRBs, the PDCP SDUs to be retransmitted where the at least one timer associated with a dependent data unit may have been triggered; for AM DRBs, the PDCP SDUs to be retransmitted where the at least one timer associated with a dependent data unit may have had a configured amount of time elapsed (e.g., 50% of time elapsed on timer); for AM DRBs, the PDCP Data PDUs to be retransmitted; for AM DRBs, the PDCP Data PDUs to be retransmitted whose corresponding at least one timer (e.g., PDCP discardTimer for a data unit and/or component/group thereof) may have been triggered; for AM DRBs, the PDCP Data PDUs to be retransmitted whose corresponding at least one timer (e.g., PDCP discardTimer associated to the data unit and/or component and/or group thereof) may have had a configured amount of time elapsed (e.g., 50% of time elapsed on timer); for AM DRBs, the PDCP Data PDUs to be retransmitted that may have a dependent data unit that is in the WTRU buffer (e.g., PDCP buffer, SDAP buffer, any L2 buffer); for AM DRBs, the PDCP Data PDUs to be retransmitted where the at least one timer associated with a dependent data unit may have been triggered; and/or for AM DRBs, the PDCP Data PDUs to be retransmitted where the at least one timer associated with a dependent data unit may have had a configured amount of time elapsed (e.g., 50% of time elapsed on timer).

There may be an association between timers at PDCP (e.g., discardTimers) of dependent data units.

In some examples, the data volume calculation for data available for transmission may be based on more than one timer, where one timer (e.g., discardTimer at PDCP) may be associated with any one or more data units, group, and/or component thereof (e.g., as described herein) and another timer (e.g., dependentdiscardTimer at PDCP) may be associated with a dependent data unit.

In some examples, timers for dependent data units, group, and/or component thereof may be associated. For example, the start of a timer for one data unit may trigger the start of a timer for another data unit. For example, expiry of a timer for one data unit may trigger expiry of a timer for another data unit. For example, the start of a timer for one data unit may trigger expiry of a timer for another data unit. For example, expiry of a timer for one data unit may trigger the start of a timer for another data unit. For example, selection of a timer for one data unit may trigger selection of a timer for another data unit. For example, if the discardTimer is selected for one data unit, the discardTimer may also be selected (e.g., by the WTRU) for a dependent data unit. For example, if the discardTimerForLowImportance is selected for one data unit, the discardTimerForLowImportance may also be selected (e.g., by the WTRU) for a dependent data unit.

The RLC may consider data available for transmission. For example (e.g., for the purpose of MAC buffer status reporting), the transmitting RLC entity may consider (e.g., only) data available for transmission as part of the RLC data volume calculation; which may include a subset or all of the data considered for RLC data volume calculation. The data considered for RLC data volume calculation, may include, for example, one or more of the following: RLC SDUs and RLC SDU segments that may not have been included in an RLC data PDU; RLC data PDUs that may be pending for initial transmission; and/or RLC data PDUs that may be pending for retransmission (RLC AM).

RLC may consider data available for transmission (e.g., as part of the RLC data volume calculation), for example, based on a timer (e.g., timer at RLC) associated with any one or more data units, group, and/or component thereof (e.g., as described herein). In some examples, there may be one timer configured per RLC SDU or RLC SDU segment. In some examples, there may be one timer configured per data unit, group, and/or component thereof, where (e.g., all) RLC SDUs or RLC SDU segments that form part of the data unit, group, and/or component thereof may be associated with the timer.

RLC may consider data available for transmission (e.g., as part of the RLC data volume calculation), for example, based on a timer (e.g., discardTimer or other timer at PDCP) associated with any one or more data units, group, and/or component thereof (e.g., as described herein). In some examples, there may be one timer configured per PDCP SDU. In some example, there may be one timer configured data unit, group, and/or component thereof, where (e.g., all) RLC SDUs or RLC SDU segments that form part of the data unit, group, and/or component thereof may be associated with the timer.

In some examples (e.g., where a data volume calculation at the RLC sublayer may be based on a timer at another sublayer, such as a discardTimer at PDCP), the RLC entity may receive from another sublayer (e.g., the PDCP sublayer) an indication, which may include, for example, any one or more of the following: amount of time left on the timer; and/or the identity of the timer and/or the data unit the timer is associated with (e.g., timer associated with RLC SDU 1, timer associated with RLC SDU segment 2, timer associated with RLC SDUs that form part of data unit 1, timer associated with RLC SDU segments that form part of a component of data unit 1, such as RLC SDU segments associated with PDU 2 of PDU set 3).

In some examples, the PDCP entity may send an indication to the RLC entity (e.g., only) if/when the timer at PDCP (e.g., discardTimer) has expired.

In some examples, the PDCP entity may send an indication to the RLC entity (e.g., only) when the timer at PDCP may have started and/or may have had a configured amount of time elapsed (e.g., 75% of time elapsed).

In some examples, data may become available upon one or more of the following events: start of the at least one timer associated with the data unit, component, and/or group thereof; expiry of the at least one timer associated with the data unit, component, and/or group thereof; configured amount of time of the at least one timer associated with the data unit, component, and/or group thereof has elapsed (e.g., 75% of time elapsed on the timer); start of the at least one timer associated with a dependent data unit, component, and/or group thereof; expiry of the at least one timer associated with a dependent data unit, component, and/or group thereof; and/or configured amount of time of the at least one timer associated with a dependent data unit, component, and/or group thereof has elapsed (e.g., 75% of time elapsed on the timer).

MAC may consider data available for transmission. The MAC entity may determine the amount of UL data available for a logical channel, for example, according to the data volume calculation at the MAC entity and/or the associated PDCP and RLC entities, respectively.

Systems, methods, and instrumentalities are described herein related to conditional availability of data for transmission, e.g., for data streams related to immersive services and/or extended reality (XR). A wireless transmit/receive unit (WTRU) may determine that a second amount of data is available for transmission (e.g., for the purpose of a scheduling request (SR), buffer status report (BSR), and/or multiplexing in a transport block (TB)) as a function of, for example, the transmission status of a first amount of data that has previously been multiplexed in a transport block, previously determined to be available for transmission, previously discarded, and/or previously successfully transmitted. The determination logic may be performed, for example, in medium access control (MAC), radio link control (RLC), and/or packet data convergence protocol (PDCP). The WTRU may use the determination to implement conditional transmission of the second amount of data.

An example device may include a processor and may be configured to perform one or more actions. For example, a device (e.g., a wireless transmit/receive unit (WTRU) may (e.g., be configured to) receive an indication of first data. The device may receive an indication of second data. The device may determine that a dependency exists between the first data and the second data. The device may determine, at a first time, that the second data is unavailable for transmission. The device may determine one or more conditions. Satisfaction of the one or more conditions may indicate that at least an amount of the second data is available for transmission. The device may determine, at a second time, that the amount of the second data is available for transmission based on satisfaction of the one or more conditions. The device may perform one or more of: processing (e.g., transmission processing) of the amount of the second data or transmission of the amount of the second data.

The determination that the dependency exists between the first data and the second data may comprise a determination that: the first data and the second data are mapped to a flow, a bearer, or a logical channel; or, information provided by a higher layer indicates the dependency between the first data and the second data. The indication may be associated with one or more of: grouping information, marking information, or time stamp information.

The determination that the second data is unavailable for transmission may be based on: a processing status of the first data; a configuration of the WTRU; or, at least one of: an attribute of the first data or an attribute of the second data.

The attribute of the first data may comprise a packet delay budget (PDB), protocol data unit (PDU) set delay budget (PSDB), PDU set delay deadline (PSDD), or PDU Set Importance (PSI). The attribute of the second data may comprise an indication that the second data has not been received (e.g., the second data may not have been received, may have been partially received (e.g., not totally received), or the received data may be corrupted).

The transmission of the amount of the second data may be performed. The amount of the second data may be a subset of the second data. The transmission of the subset of the second data may not include part of the second data. The amount of the second data may be determined, for example, based on an amount of the first data being processed for transmission. In examples, being processed for transmission may comprise being multiplexed into a transport block.

The one or more conditions may comprise one or more time-based conditions. The one or more of time-based conditions may comprise at least one of: a jitter condition associated with an expected time to receive the second data; or, a packet delay budget (PDB) condition, a protocol data unit (PDU) set delay budget (PSDB) condition, or a PDU set delay deadline (PSDD) condition.

The one or more conditions may comprise one or more event-based conditions. The one or more event-based conditions may comprise at least one of: whether the second data has been received; whether the first data is available for transmission; whether dependent data has been received; a hybrid automatic repeat request (HARQ) condition; or, a forward error correction (FEC) condition.

The one or more conditions may comprise a time-based condition and an event-based condition.

The processing of the amount of the second data may be performed. The processing of the amount of the second data may comprise multiplexing the amount of the second data into a packet data unit (PDU). The transmission of the amount of the second data may be performed.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit/receive unit (WTRU) comprising:
a receiver configured to:
receive an indication of first data;
receive an indication of second data;
determine that a dependency exists between the first data and the second data;
determine, at a first time, that the second data is unavailable for transmission, wherein the determination that the second data is unavailable for transmission is based on: a processing status of the first data; a configuration of the WTRU; or, at least one of: an attribute of the first data or an attribute of the second data;
determine one or more conditions, wherein satisfaction of the one or more conditions indicates that at least an amount of the second data is available for transmission;
determine, at a second time, that the amount of the second data is available for transmission based on satisfaction of the one or more conditions; and
perform one or more of: processing of the amount of the second data or transmission of the amount of the second data.

2. The WTRU of claim 1, wherein the determination that the dependency exists between the first data and the second data comprises a determination that: the first data and the second data are mapped to a flow, a bearer, or a logical channel; or, information provided by a higher layer indicates the dependency between the first data and the second data, wherein the indication is associated with one or more of: grouping information, marking information, or time stamp information.

3. The WTRU of claim 1, wherein the attribute of the first data comprises a packet delay budget (PDB), protocol data unit (PDU) set delay budget (PSDB), PDU set delay deadline (PSDD), or PDU Set Importance (PSI), and wherein the attribute of the second data comprises an indication that the second data has not been received.

4. The WTRU of claim 1, wherein the transmission of the amount of the second data is performed, wherein the amount of the second data is a subset of the second data, wherein the transmission of the subset of the second data does not include part of the second data, wherein the amount of the second data is determined based on an amount of the first data being processed for transmission, and wherein being processed for transmission comprises being multiplexed into a transport block.

5. The WTRU of claim 1, wherein the one or more conditions comprise one or more time-based conditions, wherein the one or more of time-based conditions comprise at least one of: a jitter condition associated with an expected time to receive the second data; or, a packet delay budget (PDB) condition, a protocol data unit (PDU) set delay budget (PSDB) condition, or a PDU set delay deadline (PSDD) condition.

6. The WTRU of claim 1, wherein the one or more conditions comprise one or more event-based conditions, wherein the one or more event-based conditions comprise at least one of: whether the second data has been received; whether the first data is available for transmission; whether dependent data has been received; a hybrid automatic repeat request (HARQ) condition; or, a forward error correction (FEC) condition.

7. The WTRU of claim 1, wherein the one or more conditions comprise a time-based condition and an event-based condition.

8. The WTRU of claim 1, wherein the processing of the amount of the second data is performed, and wherein the processing of the amount of the second data comprises multiplexing the amount of the second data into a packet data unit (PDU), and wherein the transmission of the amount of the second data is performed.

9. A method comprising:
receiving an indication of first data;
receiving an indication of second data;
determining that a dependency exists between the first data and the second data;
determining, at a first time, that the second data is unavailable for transmission, wherein the determining that the second data is unavailable for transmission is based on: a processing status of the first data; a configuration of the WTRU; or, at least one of: an attribute of the first data or an attribute of the second data;
determining one or more conditions, wherein satisfaction of the one or more conditions indicates that at least an amount of the second data is available for transmission;
determining, at a second time, that the amount of the second data is available for transmission based on satisfaction of the one or more conditions; and
performing one or more of: processing of the amount of the second data or transmission of the amount of the second data.

10. The method of claim 9, wherein the determination that the dependency exists between the first data and the second data comprises a determination that: the first data and the second data are mapped to a flow, a bearer, or a logical channel; or, information provided by a higher layer indicates the dependency between the first data and the second data, wherein the indication is associated with one or more of: grouping information, marking information, or time stamp information.

11. The method of claim 9, wherein the attribute of the first data comprises a packet delay budget (PDB), protocol data unit (PDU) set delay budget (PSDB), PDU set delay deadline (PSDD), or PDU Set Importance (PSI), and wherein the attribute of the second data comprises an indication that the second data has not been received.

12. The method of claim 9, wherein the transmission of the amount of the second data is performed, wherein the amount of the second data is a subset of the second data, wherein the transmission of the subset of the second data does not include part of the second data, wherein the amount of the second data is determined based on an amount of the first data being processed for transmission, and wherein being processed for transmission comprises being multiplexed into a transport block.

13. The method of claim 9, wherein the one or more conditions comprise one or more time-based conditions, wherein the one or more of time-based conditions comprise at least one of: a jitter condition associated with an expected time to receive the second data; or, a packet delay budget (PDB) condition, a protocol data unit (PDU) set delay budget (PSDB) condition, or a PDU set delay deadline (PSDD) condition.

14. The method of claim 9, wherein the one or more conditions comprise one or more event-based conditions, wherein the one or more event-based conditions comprise at least one of: whether the second data has been received; whether the first data is available for transmission; whether dependent data has been received; a hybrid automatic repeat request (HARQ) condition; or, a forward error correction (FEC) condition.

15. The method of claim 9, wherein the one or more conditions comprise a time-based condition and an event-based condition.

16. The method of claim 9, wherein the processing of the amount of the second data is performed, and wherein the processing of the amount of the second data comprises multiplexing the amount of the second data into a packet data unit (PDU), and wherein the transmission of the amount of the second data is performed.
